(19) United States
(12) Patent Application Publication
(10) Pub. No.: US 2026/0287317 A1
(43) Pub. Date: Sep. 24, 2026

(54) SYSTEMS, APPARATUSES, AND METHODS FOR DELIVERING EXPLOSIVE COMPOSITIONS INTO BOREHOLES

(71) Applicant: Orica International Pte Ltd, Singapore (SG)

(72) Inventors: Darren MORTON, Maryland, New South Wales (AU); Jennifer Liane ROWE, Edgeworth, New South Wales (AU); Mark Richard HANCOCK, Warners Bay, New South Wales (AU); Adam Kurt SCHNELLER, Bonnells Bay, New South Wales (AU); Greg RIGBY, Charlestown, New South Wales (AU)

(21) Appl. No.: 19/168,970

(22) PCT Filed: Mar. 26, 2024
(86) PCT No.: PCT/SG2024/050177

§ 371 Date: Sep. 25, 2025

Related U.S. Application Data
(60) Provisional application No. 63/492,238, filed on Mar. 26, 2023.

(51) Int. Cl. F42D 1/10

(52) U.S. Cl. CPC F42D 1/10

(57) ABSTRACT

Methods of charging boreholes for commercial blasting including charging a borehole with an explosive composition. This involves dispensing the explosive composition from an outlet structure in the borehole. While charging the borehole, the fill rate of the explosive composition into the borehole is selectively varied to provide at least one physical pattern in the explosive composition that includes two or more cavities. Selectively varying the fill rate selectively controls sizes and locations of the two or more cavities.

### RELATED APPLICATION

The present application is related to U.S. Provisional Patent Application No. 63/492,238, entitled “Systems, apparatuses, and methods for delivering explosive compositions into boreholes”, the originally filed specification of which is hereby incorporated by reference in its entirety herein.

### TECHNICAL FIELD

Aspects of the present disclosure relate to systems, apparatuses, and methods for conveying explosive composition constituents and charging (including delivering or loading) explosive compositions formed therefrom into boreholes.

### BACKGROUND

In association with various commercial blasting situations, an array of boreholes is formed or drilled in portions of a geologic formation, and subsequently the array of boreholes is loaded with an explosive composition or material by way of flowing explosive composition constituents through a borehole loading hose. Such explosive composition constituents commonly include an explosive composition precursor or intermediate material, for instance, Ammonium Nitrate Emulsion (ANE), and one or more sensitizing agents such as a chemical gassing agent, which when combined or mixed together in association with the loading or delivery thereof into the array of boreholes form the explosive composition, at which point the array of boreholes can be categorized or defined as an array of blastholes that has been charged with the explosive composition.

It can be advantageous with respect to achieving one or more intended blast outcomes if an array of blastholes in a geologic formation has been charged with an explosive composition such that the explosive composition's energy intentionally varies in one or more manners between particular blastholes, and/or within or along the length, depth, or central axis of certain individual blastholes themselves. Such intentional explosive composition energy variation can be based on or correspond to a blast design that considers or accounts for variations in rock properties across and/or within portions of the geologic formation corresponding to the array of boreholes (e.g., where such rock properties are correlated with or determined based on measure-while-drilling (MWD) results, in a manner readily understood by individuals having ordinary skill in the relevant art).

Ideally, such explosive composition energy variation should be achievable in a manner that is operationally feasible with respect to the use of well-known or widely used explosive composition constituents, for instance, including ANE and a set of sensitizing agents therefor.

As an explosive composition constituent, ANE (e.g., bulk ANE) is quite commonly used in association with borehole loading in commercial blasting operations, for instance, in many underground mining situations, as it provides a number of advantages with respect to commercial blasting operation scale and safety. For instance, the conveyance of ANE in association with borehole loading operations can occur by way of highly productive borehole loading equipment and techniques that minimize manual labor and material handling requirements. Additionally, explosive compositions based on ANE can be loaded into water-containing boreholes without compromising explosive properties.

A typical technique of loading explosive composition constituents including ANE and a sensitizing agent therefor into a borehole involves the insertion of a loading hose or conduit into a far, distal, or terminal portion of the borehole (e.g., the borehole's “toe”), with an explosive initiation device or primer disposed on the end of the loading hose. The primer is positioned at a particular location in the borehole in accordance with a blast design, after which pumping of the explosive composition constituents through the loading hose; mixing of the explosive composition constituents in association with the flow thereof through a portion of the loading hose, one or more static mixers, and/or an outlet structure thereof to give rise to at least the initial formation of the explosive composition; and delivery of (i) an explosive composition currently undergoing formation (e.g., by way of chemical reactions), or (ii) the as-formed explosive composition into the borehole by way of the outlet structure occurs. For purpose of brevity and simplicity, an explosive composition currently undergoing formation (e.g., by way of chemical reactions), and an as-formed or fully-formed explosive composition are each referred to hereafter as an explosive composition.

As the borehole is filled across its diameter and along its length with the explosive composition, the loading hose is either progressively (a) pushed further and further out of the borehole by the viscous explosive composition itself that has been delivered into the borehole as the borehole is filled thereby; or (b) retracted at a controlled rate to maintain an intended or optimal gap between the outlet structure and the column of explosive composition delivered into the borehole. Pumping of the ANE continues until either an intended mass of ANE has been delivered into the borehole, or a target initial explosive charge length along the borehole has been reached.

Relative to an ANE-based explosive composition, ANE is converted from an explosive composition precursor material into an explosive composition or material by way of the addition of one or more sensitizing agents thereto, which mixed (e.g., thoroughly mixed) with the ANE to form or lead to the formation of small voids that can act as “hot spots” in the ANE matrix when subjected to compression by an explosive shock wave, thus enhancing detonation sensitivity and aiding or ensuring reliable propagation of detonation. With respect to a chemical sensitizing agent or chemical gassing agent, the chemical gassing agent reacts with ammonium nitrate in the ANE to form small gas bubbles suspended in the viscous ANE matrix, and these small gas bubbles can act as such “hot spots”.

With respect to the addition of a chemical gassing agent to ANE, explosive material expansion in-hole must be accounted for when the ANE is chemically sensitized because the chemical reactions between the gassing agent and the ammonium nitrate in the ANE take a given amount of time to complete. A final explosive charge length can be calculated by multiplying the initial target explosive charge length by an expected material expansion factor based on the explosive composition constituents and delivery parameters used.

The volumetric ratio of sensitizing agent (such as a chemical gassing agent) to ANE, or the concentration of active agent in the chemical gassing agent, can be varied to achieve a range of explosive composition densities and therefore available explosive composition energies from hole-to-hole and/or in-hole, for instance, to achieve an intended powder factor distribution in accordance with a blast design and an intended blast outcome. Unfortunately, existing systems, apparatuses, and methods for selectively or selectably varying the energy of explosive compositions delivered into boreholes are undesirably limited with respect to the overall range of explosive composition energies that can be achieved in-hole (e.g., in a manner that can reliably and predictably enhance the likelihood of realizing an intended blast outcome).

A chemical gassing agent can be incorporated into an aqueous lubricating layer which forms an annulus around ANE explosive precursor material as it is conveyed through portions of the loading hose, in a manner readily understood by individuals having ordinary skill in the relevant art. The chemical gassing agent is mixed with the ANE precursor material, for instance, by way of a static mixer disposed at a particular location along the length of the loading hose (e.g., proximate or adjacent to the outlet structure of the loading hose) in order to commence chemical reaction between the gassing agent and the ANE precursor material.

Unfortunately, the actual achieved density and expansion of the ANE explosive material in the blasthole can vary significantly, thus potentially adversely affecting blast outcome, for instance, based on one or more of:
blasthole angle, diameter, and explosive charge length loaded;
borehole condition, including the presence of water and/or dust therein, and the underlying competency of the geological formation in which the borehole resides;
inconsistency or undesired variability in the ratio of chemical gassing agent active ingredient to the ANE explosive precursor material;
in-hole temperature or temperature profile;
the level of shear or mixing that the typically non-Newtonian ANE explosive precursor material experiences during the borehole loading process; and
rheological properties of the final in-hole explosive composition.

With respect to an expected blast design, such factors can undesirably give rise to inaccuracies in explosive charge lengths and/or variations in explosive material density along the length of a blasthole and/or between blastholes.

In WO199855805 (Perlid), an alternative borehole loading technique is described, whereby an ANE explosive composition is sprayed laterally onto the circumferential surface or wall of the borehole while the loading hose is retracted at a controlled rate to thereby leave a central void inside the ANE explosive composition column that has been loaded into the borehole. The central void extends continuously along the length of the column that is aligned with the longitudinal axis of the borehole. Typically, the ratio of chemical gassing agent to ANE explosive precursor material and the loading hose retraction rate are controlled such that the ANE explosive composition is expected to expand by way of chemical gassing reactions to fill-in this central void and achieve an intended explosive composition density or density profile within the blasthole without causing the explosive material column to expand lengthwise or longitudinally along the length of the blasthole. The borehole loading technique in WO199855805 (Perlid) appears to require a centralizer, in the form of a pair of centering devices 14 arranged on the charging hose adjacent to its free end, to keep the charging hose centered in the borehole during the outflowing.

Unfortunately, due to loading inaccuracies, even after completion of the chemical gassing reactions one or more central void regions in the explosive composition can still be present at entirely unforeseen or entirely unpredictable locations along the length of the blasthole, which presents a risk for a poor blast outcome due to the potential for (a) explosive composition slumping away from the blasthole wall into the central void region(s) to occur (e.g., in response to vibrations communicated to the blasthole from nearby or adjacent blasts); (b) the reduction of explosive composition column length along the blasthole; and/or (c) incomplete detonation of the explosive charge in one or more central void regions (e.g., resulting from explosive shockwave development and propagation in the central void region at a velocity higher than that of the detonation front associated with the shockwave, where such a shockwave can compress the sensitized explosive composition above its critical density, and detonation is no longer sustained).

A need exists for a system, apparatus, and/or method by which (i) explosive composition constituents can be conveyed and mixed to produce explosive compositions having selectably or selectively varied energies across an increased or wider explosive composition energy range than previously available; and (ii) such explosive compositions can be delivered into boreholes in a manner that facilitates maintenance of in-hole explosive composition integrity and predictability in detonation properties, thereby increasing the likelihood of reliably achieving intended blast design objectives or outcomes.

It is desired to address or alleviate one or more disadvantages or limitations of the prior art, or to at least provide a useful alternative.

### SUMMARY

In accordance with an aspect of the present disclosure, a method of charging (also referred to as loading, which includes delivering, dispensing, or introducing an explosive composition into a borehole) at least one borehole for commercial blasting comprises:
charging a borehole with an explosive composition by dispensing the explosive composition from an outlet structure (nozzle) in the borehole; and
selectively varying, while charging the borehole, a fill rate of the explosive composition into the borehole to provide at least one physical pattern in the explosive composition that includes two or more cavities (which include substantially air (or “air phase”/“gas phase”, which is distinct from the “fluid phase” or “solid phase” of the explosive composition) and are referred to as air cavities, air pockets, air gaps, air regions, air phase regions, cavity regions, or macro-voids-thus the physical pattern defines a repeated structure, and generally a regular repeated structure, formed by the two or more cavities and the explosive composition around the two or more cavities, e.g., on all sides of each cavity, or substantially along one or more of the sides of each cavity, such that the cavity prevents the explosive composition in the macro-void containing region from extending across or spanning the entire width of the particular borehole),
wherein the selective varying of the fill rate selectively controls (and thus defines) sizes and locations of the two or more cavities (thus providing effective selection of, and thus control of, and thus selective variation of, the relative bulk strength (RBS) of the explosive composition corresponding to the physical pattern).

The selective varying of the fill rate may include selective varying of a retraction rate of the outlet structure from the borehole.

The selective varying of the fill rate may include controlling/selecting the retraction rate (also known as the hose rate) based on a target bulk density (or a target bulk density profile along the borehole), wherein the target bulk density (in kg/meter) is proportional to the delivery rate (in kg/second) and inversely proportional to the retraction rate (in meters/second). (In other words, the RBS is correlated to mass (in kg) of the explosive composition per length (in m) along borehole, so based on the diameter of the borehole, and the current/instantaneous flow rate, the current/instantaneous retraction rate can be controlled, during the charging, in order to provide an instantaneous target RBS at each portion along of the borehole (and thus a target RBS profile along the borehole).)

The selective varying of the fill rate may include selective varying of a flow rate of the explosive composition from the outlet structure.

The flow rate of the explosive composition (including currently-forming and/or as-formed explosive composition) from the outlet structure may vary repeatedly (e.g., cyclically or periodically) as a function of time in a manner that is correlated with the physical pattern (specifically, repeated structures in the physical pattern provided by the cavities).

The flow rate may vary repeatedly with a selected spatial frequency (and optionally a selected spatial duty cycle), wherein the selected spatial frequency includes one or more of:
substantially 35 mm;
substantially 40 mm; and
Substantially 50 mm.

The flow rate of the explosive composition (including currently-forming and/or as-formed explosive composition) from the outlet structure may vary repeatedly (e.g., cyclically or periodically) as a function of time in a manner that is correlated with repeated variation (e.g., cyclical or periodic) in a flow rate of an explosive composition precursor stream that is used to form the explosive composition.

The flow rate may be varied based on an amount of explosive composition precursor per pump stroke (e.g., substantially 600 or 650 grams).

The method may include selecting (e.g., establishing, e.g., on a selective or selectable basis, such as a programmable basis) a speed, rate, frequency, or period of the flow rate of the explosive composition precursor stream (e.g., at which the operational mechanism of the explosive composition precursor pump is driven).

The method may include adjusting (e.g., dampening) pressure variations (also referred to as “swing”) in the explosive composition precursor stream (using a pulsation dampener).

The method may include:
producing the explosive composition precursor stream (e.g., an ammonium nitrate emulsion (ANE) stream) in an explosive composition precursor conduit or line, (wherein the explosive composition precursor pump is configured as a positive displacement pump having an operational mechanism that functions in a cyclical, oscillating, periodic, or reciprocating manner to intentionally output the explosive composition precursor stream in accordance with a flow rate that cyclically or periodically varies as a function of time within each single cycle or period of the operational mechanism));
producing a sensitizing agent stream (e.g., a chemical gassing agent stream and/or a stream of one or more sensitizing agents that can sensitize the explosive composition precursor without requiring chemical reaction therewith, such as solid or already-formed sensitizing agents, for instance, glass or plastic microballoons, expanded polystyrene beads or microbeads, or non-chemically/mechanically formed gas bubbles) having a selectively or selectably (e.g., adjustably or programmably) established flow rate (e.g., as a constant or varying/variable gassing agent flow rate, or in accordance with a gassing agent flow rate function); and
merging (e.g., introducing or injecting or vice versa) the sensitizing agent stream and the explosive composition stream to produce a combined stream that forms the explosive composition that is used to provide the physical pattern.

The method may include pumping the explosive composition precursor stream using a piston (e.g., which is configured for reciprocating motion inside of a cylinder).

The merging may include mixing the sensitizing agent stream and the explosive composition stream in a Venturi-type lumen structure.

The method may include flowing the (water-lubricated) explosive composition precursor stream and the sensitizing agent stream (into the borehole) in a multi-channel hose (also referred to as a “conduit”).

The method may include mixing the sensitizing agent stream and the explosive precursor composition stream (referred to as the “explosive composition constituents”), to form the explosive composition, by flow of the sensitizing agent stream and the explosive precursor composition stream through one or more of:
a portion of the multi-channel hose (also referred to as a “loading hose”),
one or more static mixers in the outlet structure and/or in a final segment of the multi-channel hose, and
the outlet structure.

(The hose may include a final conduit or hose segment which separates the outlet structure's nozzle from the stream merging assembly by at least 1 m, e.g., between, 1.0-2.0 m, or 1.25-1.75 m, or 1.5 m.)

The method may include:
injecting the explosive composition precursor stream into a lubrication water stream to produce a water-lubricated explosive composition precursor stream having an explosive composition precursor core surrounded by an annulus of water,
wherein the lubrication water stream varies repeatedly (e.g., cyclically or periodically) as a function of time in a manner that is correlated with the repeated variation in the flow rate of the explosive composition precursor stream.

The method may include including repeatedly varying the lubrication water stream with a predetermined fractional displacement amplitude (also referred to as swing) of less than 100% (e.g., between approximately 10%-40% or approximately 15%-35% or approximately 25%) relative to (or of) a displacement amplitude (also referred to as swing) of the repeated variation of the explosive composition precursor.

The method may include:
dispensing the explosive composition from the outlet structure (e.g., dispensing or ejecting currently-forming and/or as-formed explosive composition (e.g., in a circumferential manner around the dispensing/spray nozzle) laterally toward side walls (e.g., the sides or walls) of the borehole when the outlet structure is disposed in the borehole (e.g., predominantly dispensing or ejecting currently-forming and/or as-formed explosive composition onto the sides or walls of the borehole rather than toward the terminal or distal end or bottom of the borehole).

The method may include laterally dispensing (due to ejecting) the explosive composition toward and onto the sides or walls of a borehole predominantly at or at an angle of 70 degrees offset from a lengthwise or longitudinal axis of a borehole in a vector direction opposite to a vector direction along which the outlet structure is retracted or withdrawn from the borehole, or an angle range of 60-80 degrees (e.g., 65-75 degrees) offset of the lengthwise or longitudinal axis of the borehole in a vector direction opposite to a vector direction along which the outlet structure is retracted or withdrawn from the borehole.

The method may include:
charging a first array of boreholes with a first explosive composition characterized by a first explosive composition physical pattern (e.g., having a first non-zero volumetric percentage or percentage range of macro-void content), for instance, based on a first set of rock properties or rock property values associated with the first array of boreholes;
charging a second array of boreholes with a second explosive composition characterized by a second explosive composition physical pattern (e.g., having by a distinct second non-zero volumetric percentage or percentage range of macro-void content), for instance, based on a second set of rock properties or rock property values associated with the second array of boreholes; and
charging a third array of boreholes with a third explosive composition that lacks explosive composition physical patterns, such that the volumetric macro-void content of the third explosive composition is zero, or the third array of boreholes intentionally omits or excludes any explosive composition having an explosive composition physical pattern, for instance, based on a third set of rock properties or rock property values associated with the third array of boreholes.

The method may include:
charging a selected borehole (within an array of boreholes (e.g., one or more boreholes within the aforementioned first array of boreholes or the second array of boreholes) with two or more mutually distinct explosive composition physical patterns (e.g., corresponding to two different non-zero macro-void content percentages or percentage ranges) along a lengthwise axis (also referred to as longitudinal axis) of the selected borehole.

The method may include changing the selective varying of the fill rate (e.g., changing the function that varies with time), while charging the borehole, to form the two or more mutually distinct explosive composition physical patterns during the charging of the selected borehole.

In accordance with an aspect of the present disclosure, a system for charging at least one borehole for commercial blasting, the system comprises:
an outlet structure (nozzle) for dispensing an explosive composition in the borehole to charge the borehole with the explosive composition; and
a control system (e.g., including first programmable speed encoder of ANE pump and flow meter/controller of chemical gassing agent) for selectively varying, while charging the borehole, a fill rate of the explosive composition into the borehole to provide at least one physical pattern in the explosive composition that includes two or more cavities (which include substantially air (or “air phase”/“gas phase”, which is distinct from the “fluid phase” or “solid phase” of the explosive composition) and are referred to as air cavities, air pockets, air gaps, air regions, air phase regions, cavity regions, or macro-voids—thus the physical pattern defines a repeated structure, and generally a regular repeated structure, formed by the two or more cavities and the explosive composition around the two or more cavities, e.g., on all sides of each cavity, or substantially along one or more of the sides of each cavity, such that the cavity prevents the explosive composition in the macro-void containing region from extending across or spanning the entire width of the particular borehole),
wherein the selective varying of the fill rate selectively controls (and thus defines) sizes and locations of the two or more cavities (thus providing effective selection of, and thus control of, and thus selective variation of, the relative bulk strength (RBS) of the explosive composition corresponding to the physical pattern).

(The control system may set the system parameters that can be selectively or selectably (e.g., adjustably or programmably) established or varied to provide an intended macro-void percentage content, and which can include one or more of: ANE pump intake/discharge volume (e.g., which can correspond to or be correlated with piston stroke length); the rate, frequency, or periodicity of the ANE pump's operational mechanism (e.g., piston); the (pre or re)charging pressure of the pulsation dampener; the sensitizing or chemical gassing agent pump intake/discharge volume; the sensitizing or gassing agent flow rate; and the retraction rate of the additional or final conduit or hose segment/outlet structure from a borehole.)

The selective varying of the fill rate may include selective varying of a retraction rate of the outlet structure from the borehole.

The selective varying of the fill rate may include selective varying of a flow rate of the explosive composition from the outlet structure.

The flow rate of the explosive composition (including currently-forming and/or as-formed explosive composition) from the outlet structure may vary repeatedly (e.g.,, cyclically or periodically) as a function of time in a manner that is correlated with the physical pattern (specifically, repeated structures in the physical pattern provided by the cavities).

(An average size, size distribution, spatial volume, or spatial volume distribution of the macro-scale compartments, cavities, or chambers and/or constrictions in the explosive composition may be correlated with the pulsatile, periodic, or oscillating flow rate of explosive composition precursor and/or explosive composition in portions of the system that reside external to the borehole. The pulsatile, periodic, or oscillating flow rate may corresponds to the cyclical, periodic, or reciprocating operation of a positive displacement pump.)

The flow rate of the explosive composition (including currently-forming and/or as-formed explosive composition) from the outlet structure may vary repeatedly (e.g., cyclically or periodically) as a function of time in a manner that is correlated with repeated variation (e.g., cyclical or periodic) in a flow rate of an explosive composition precursor stream that is used to form the explosive composition.

The control system may include a (first) speed encoder configured for establishing (e.g., on a selective or selectable basis, such as a programmable basis) a speed, rate, frequency, or period (at which the operational mechanism of the explosive composition precursor pump is driven) of the flow rate of the explosive composition precursor stream.

The system may include a pulsation dampener for adjusting (i.e., dampening) pressure variations (or “swing”) in the explosive composition precursor stream.

The system may include:
an explosive composition precursor pump configured to produce the explosive composition precursor stream (e.g., an ammonium nitrate emulsion (ANE) stream) in an explosive composition precursor conduit or line, (wherein the explosive composition precursor pump is configured as a positive displacement pump having an operational mechanism that functions in a cyclical, oscillating, periodic, or reciprocating manner to intentionally output the explosive composition precursor stream in accordance with a flow rate that cyclically or periodically varies as a function of time within each single cycle or period of the operational mechanism);
a sensitizing agent pump fluidically coupled to a flow meter/controller, wherein the sensitizing agent pump and the flow meter/controller are configured to produce a sensitizing agent stream (e.g., a chemical gassing agent stream and/or a stream of one or more sensitizing agents that can sensitize the explosive composition precursor without requiring chemical reaction therewith, such as solid or already-formed sensitizing agents, for instance, glass or plastic microballoons, expanded polystyrene beads or microbeads, or non-chemically/mechanically formed gas bubbles) having a selectively or selectably (e.g., adjustably or programmably) established flow rate (e.g., as a constant or varying/variable gassing agent flow rate, or in accordance with a gassing agent flow rate function); and
a stream merging assembly configured to merge (e.g., introducing or injecting or vice versa) the sensitizing agent stream and the explosive composition stream (to produce a combined stream that includes, is essentially, or is an initially-formed explosive composition) that forms the explosive composition (from or of the initially-formed explosive composition) to provide the physical pattern in the explosive composition.

An operational mechanism of the explosive composition precursor pump may include a piston for pumping the explosive composition precursor stream (e.g., which is configured for reciprocating motion inside of a cylinder).

The stream merging assembly may include a Venturi-type lumen structure for merging the sensitizing agent stream and the explosive composition precursor stream.

The system may include a multi-channel hose for flowing the (water-lubricated) explosive composition precursor stream in a first lumen and the sensitizing agent stream in a second lumen (or “conduit”).

One or more of the following may be configured to mix the sensitizing agent stream and the explosive precursor composition stream (or the “explosive composition constituents”), to form the explosive composition:
a portion of the multi-channel hose (or “loading hose”),
one or more static mixers in the outlet structure and/or in a final segment of the multi-channel hose, and/or
the outlet structure.

The system may include:
a lubrication water pump configured to produce a lubrication water stream; and
a lubrication water injector configured to produce a water-lubricated explosive composition precursor stream having an explosive composition precursor core surrounded by an annulus of water,
wherein the lubrication water pump includes an operational mechanism that is driven by the control system to repeatedly vary (e.g., cyclically or periodically) the lubrication water stream as a function of time in a manner that is correlated with the repeated variation in the flow rate of the explosive composition precursor stream.

The operational mechanism may be driven with a predetermined fractional displacement amplitude (or swing) of less than 100% (e.g., between approximately 10% 40% or approximately 15%-35% or approximately 25%) relative to (or of) a displacement amplitude (or swing) of the repeated variation of the explosive composition precursor.

The outlet structure may include at least one output port (dispensing/spray channel, opening, or port) configured to dispense the explosive composition from the outlet structure (e.g., dispensing or ejecting currently-forming and/or as-formed explosive composition (e.g., in a circumferential manner around the dispensing/spray nozzle) laterally toward side walls (e.g., the sides or walls) of the borehole when the outlet structure is disposed in the borehole (e.g., predominantly dispensing or ejecting currently-forming and/or as-formed explosive composition onto the sides or walls of the borehole rather than toward the terminal or distal end or bottom of the borehole).

The at least one output port may be configured laterally dispense (due to ejecting) the explosive composition toward and onto the sides or walls of a borehole predominantly at or at an angle of 70 degrees offset from a lengthwise or longitudinal axis of a borehole in a vector direction opposite to a vector direction along which the outlet structure is retracted or withdrawn from the borehole, or an angle range of 60-80 degrees (e.g., 65-75 degrees) offset of the lengthwise or longitudinal axis of the borehole in a vector direction opposite to a vector direction along which the outlet structure is retracted or withdrawn from the borehole.

The system may be carryable or carried by a moveable or (trans)portable platform or a vehicle.

In accordance with an aspect of the present disclosure, an explosive composition in at least one borehole (in a portion of the borehole) for commercial blasting comprises at least one physical pattern in the explosive composition that includes two or more cavities (which include substantially air (or “air phase”/“gas phase”, which is distinct from the “fluid phase” or “solid phase” of the explosive composition) and are referred to as air cavities, air pockets, air gaps, air regions, air phase regions, cavity regions, or macro-voids—thus the physical pattern defines a repeated structure, and generally a regular repeated structure, formed by the two or more cavities and the explosive composition around the two or more cavities, e.g., on all sides of each cavity, or substantially along one or more of the sides of each cavity, such that the cavity prevents the explosive composition in the macro-void containing region from extending across or spanning the entire width of the particular borehole), and wherein sizes and locations of the two or more cavities (along the borehole) define (and thus control) a relative bulk strength (RBS) of the explosive composition corresponding to the physical pattern.

The explosive composition corresponding to the physical pattern in the borehole may have:
up to 30% of its volume occupied by the two or more cavities; and/or
at least a non-zero percentage (e.g., 1%) of its volume occupied by the two or more cavities.

(The explosive composition may be loaded into a first array of boreholes with a first explosive composition characterized by a first explosive composition physical pattern (e.g., having a first non-zero volumetric percentage or percentage range of macro-void content), for instance, based on a first set of rock properties or rock property values associated with the first array of boreholes.)

The explosive composition corresponding to the physical pattern in the borehole may have at least 10%, 15%, 20%, or 25% of its volume occupied by the two or more cavities (which may be referred to as having a void ratio of at least 10%, 15%, 20%, or 25%).

The relative bulk strength (RBS) of the explosive composition corresponding to (i.e., including the cavities and the explosive composition) the physical pattern may be one or more of the following: up to 150; up to 170; at least 50; and at least 70. In implementations using a plurality of target RBS values in one borehole, or across a plurality of boreholes, embodiments of the present disclosure can load a plurality of the physical patterns in the borehole, or across a plurality of boreholes, with mutually different RBS values up to 100 apart, including from 50 to 150 (e.g., for an explosive composition with substantially 20% water, and for an explosive composition with substantially 80% AN), or from 70 to 170 (e.g., for an explosive composition with substantially 17% water, and for an explosive composition with substantially 83% AN).

The physical pattern may include:
some or all of the cavities substantially centrally located in the borehole (e.g., generally along a central longitudinal axis of the borehole); and/or
some or all of the cavities located off-center in the borehole (e.g., with centroids offset from the longitudinal axis of the borehole).

The explosive composition corresponding to the physical pattern may include the explosive composition having a thickness range away from a wall of the borehole such that the explosive composition corresponding to the physical pattern surrounds the two or more cavities on all sides of each cavity.

The at least one physical pattern may include a bridge (also referred to as a constriction region, in-fill region, or pinch region) formed of the explosive composition between adjacent ones of the two or more cavities along the borehole (and the physical pattern includes one fewer bridge than the number of the cavities—because the bridges are alternatingly interposed with the cavities)

The bridge may include the explosive composition extending across (or spanning) at least 40% (e.g., 40% to 100%, 40% to 80%, or 45%, 50%, 55%, 60%, 65%, 70% or 75% to 100%) of the borehole's width where the bridge is located

Relative to the width of the particular borehole, each cavity may have a width that is at least 20% (e.g., at least 25%, 30%, 35%, 40%, 45%, or 50%) greater than the width of explosive composition gaps that may exist in the bridge directly adjacent to the cavity.

Each bridge may have a longitudinal depth of approximately 20+/−5 mm.

The cavities (also referred to herein as “macro-voids”) may be at least one order of magnitude larger than sensitizing voids (also referred to herein as “micro-voids”) in the explosive composition.

The sensitizing voids may have an average diameter of between 10 and 100 micrometers, and the cavities may have an average diameter of at least approximately 2 to 10 mm, or at least approximately 5 to 10 mm.

The cavities may occupy approximately 10%, approximately 15%, or approximately 20% of an overall spatial volume of the physical pattern.

Each cavity may have a longitudinal length of approximately 50+/−10 mm.

Each cavity may be surrounded by a wall material of the explosive composition with a thickness of approximately 15+/−5 mm.

The explosive composition forming the physical pattern may have an effective yield stress of at least 300 Pascal, at least 325 Pascal, or at least 350 Pascal, or at least 370 Pascal.

In accordance with an aspect of the present disclosure, an outlet structure for charging at least one borehole for commercial blasting comprises:
a nozzle tip with a plurality of output ports in an outlet end face of the nozzle tip for ejecting the explosive composition from the nozzle tip in a corresponding plurality of helical streams.

The plurality of output ports (e.g., mutually evenly spaced around, forming a circle, the centre of an outlet face of the nozzle tip) may include any one or more of:
10 output ports (e.g., in the form of dispersion facets);
8 output ports (e.g., in the form of dispersion facets);
at least 4, 6 or 8 output ports (e.g., in the form of dispersion facets); and
up to 10, 12 or 14 output ports (e.g., in the form of dispersion facets).

In accordance with an aspect of the present disclosure, an outlet structure for charging at least one borehole for commercial blasting comprises:
a plurality of primary output ports for ejecting the explosive composition onto walls of the borehole to form an at least partial coating of the explosive composition on the walls; and
a plurality of secondary output ports for ejecting the explosive composition at least partially onto the coating during withdrawal of the outlet structure from the borehole.

The primary ports may eject the explosive composition at a first angle relative to a longitudinal axis of a hose corresponding to an angle of the primary ports, and the secondary ports may eject the explosive composition at a second angle relative to the longitudinal axis of the hose corresponding to an angle of the secondary ports, wherein the second angle is different from the first angle.

The plurality of secondary ports may include a plurality of dispersion facets in an outlet end face of the outlet structure for ejecting the explosive composition in a corresponding plurality of helical streams at least partially onto the coating.

The plurality of primary ports may include any one or more of (e.g., mutually evenly circumferentially spaced around the nozzle tip):
8 ports;
at least 4 ports; and
up to 16 ports.

The plurality of secondary ports (mutually evenly spaced around, forming a circle, the centre of an outlet face of the nozzle tip) may include any one or more of:
10 secondary ports (in the form of dispersion facets);
8 secondary ports (in the form of dispersion facets);
at least 4, 6 or 8 secondary ports (in the form of dispersion facets); and
up to 10, 12 or 14 secondary ports (in the form of dispersion facets).

In accordance with an aspect of the present disclosure, a system for delivering, dispensing, or introducing an explosive composition into a borehole includes: an explosive composition precursor pump configured to produce an explosive composition precursor stream (e.g., an ammonium nitrate emulsion (ANE) stream) in an explosive composition precursor conduit or line, wherein the explosive composition precursor pump is configured as a positive displacement pump having an operational mechanism that functions in a cyclical, oscillating, periodic, or reciprocating manner to intentionally output the explosive composition precursor stream in accordance with a flow rate that cyclically or periodically varies as a function of time within each single cycle or period of the operational mechanism; a sensitizing agent pump fluidically coupled to a flow meter/controller, wherein the sensitizing agent pump and the flow meter/controller fluidically coupled thereto are configured to produce in a sensitizing agent conduit or line a sensitizing agent stream (e.g., a chemical gassing agent stream and/or a stream of one or more sensitizing agents that can sensitize the explosive composition precursor without requiring chemical reaction therewith, such as solid or already-formed sensitizing agents, for instance, glass or plastic microballoons, expanded polystyrene beads or microbeads, or non-chemically/mechanically formed gas bubbles) having a selectively or selectably (e.g., adjustably or programmably) established flow rate (e.g., as a constant or varying/variable gassing agent flow rate, or in accordance with a gassing agent flow rate function); a stream merging assembly having a first input fluidically coupled to the explosive composition precursor line and a second input fluidically coupled to the gassing agent line, wherein the stream merging assembly is configured to introduce or inject the gassing agent stream into the explosive composition stream (or vice versa) to produce at an output of the stream merging assembly a combined stream that includes, is essentially, or is an initially-formed explosive composition; and an outlet structure fluidically coupled to the output of the stream merging assembly (e.g., and having a dispensing/spray nozzle fluidically coupled thereto), and configured for dispensing or ejecting currently-forming and/or as-formed explosive composition (e.g., in a circumferential manner around the dispensing/spray nozzle) laterally toward the sides or walls of a borehole when the outlet structure is disposed in the borehole (e.g., predominantly dispensing or ejecting currently-forming and/or as-formed explosive composition onto the sides or walls of the borehole rather than toward the terminal or distal end or bottom of the borehole).

In accordance with an additional aspect of the present disclosure, a flow rate of the currently-forming and/or as-formed explosive composition dispensed or ejected from the outlet structure (e.g., by way of the dispensing/spray nozzle) cyclically or periodically varies as a function of time in a manner that is correlated with the cyclical or periodic variation in the flow rate of the explosive composition precursor stream.

In accordance with a further aspect of the present disclosure, the system is configurable or configured for charging boreholes (e.g., in a commercial blasting environment) with explosive compositions by way of dispensing or loading explosive compositions therein, wherein such explosive compositions include explosive composition physical patterns having bridge or constriction/in-fill/pinch regions alternatingly interposed with macro-void containing regions, wherein in a particular borehole each bridge or constriction/in-fill/pinch region includes an explosive composition that extends across or spans at least 40-80% (e.g., at least 45%, 50%, 55%, 60%, 65%, 70%, or 75%) of the width of the particular borehole or the across entire width of the particular borehole, wherein each macro-void containing region includes an explosive composition having a thickness range away from a wall of the particular borehole and a macro-void or cavity disposed therein such that the macro-void or cavity prevents the explosive composition in the macro-void containing region from extending across or spanning the entire width of the particular borehole, and wherein relative to the width of the particular borehole each macro-void or cavity has a width that is at least 20% (e.g., at least 25%, 30%, 35%, 40%, 45%, or 50%) greater than the width of explosive composition gaps that may exist in bridge or constriction/in-fill/pinch regions directly adjacent to the macro-void or cavity.

In accordance with a further aspect of the present disclosure, the dispensing/spray nozzle has a dispensing/spray channel, opening, or port configured to laterally dispense or eject explosive composition toward and onto the sides or walls of a borehole (e.g., predominantly at or at an angle of 70 degrees offset from a lengthwise or longitudinal axis of a borehole in a vector direction opposite to a vector direction along which the outlet structure is retracted or withdrawn from the borehole, or an angle range of 60-80 degrees (e.g., 65-75 degrees) offset of the lengthwise or longitudinal axis of the borehole in a vector direction opposite to a vector direction along which the outlet structure is retracted or withdrawn from the borehole.

In accordance with a further aspect of the present disclosure, the system is carryable or carried by a moveable or (trans)portable platform or a vehicle.

In accordance with a further aspect of the present disclosure, the operational mechanism of the explosive composition precursor pump includes a piston (e.g., which is configured for reciprocating motion inside of a cylinder).

In accordance with a further aspect of the present disclosure, the explosive composition precursor pump and the explosive composition precursor line are fluidically coupled to a pulsation dampener configured to adjust or dampen a pressure swing or variation produced at the output of the explosive composition precursor pump.

In accordance with an additional aspect of the present disclosure, the explosive composition precursor pump is coupled to a first speed encoder configured for establishing (e.g., on a selective or selectable basis, such as a programmable basis) a speed, rate, frequency, or period at which the operational mechanism of the explosive composition precursor pump is driven.

In accordance with a further aspect of the present disclosure, the system includes a lubrication water pump configured to produce a lubrication water stream in a lubrication water conduit or line; and a lubrication water injector fluidically coupled by way of a first input to the lubrication water line and by way of a second input to the explosive composition precursor line, wherein the lubrication water injector has an output configured to produce in a water-lubricated explosive precursor composition conduit or line a water-lubricated explosive composition precursor stream having an explosive composition precursor core surrounded by an annulus of water (e.g., a lubrication water annulus), and wherein the stream merging assembly is fluidically coupled to the explosive composition precursor line by way of the water-lubricated explosive composition precursor line.

In accordance with another aspect of the present disclosure, the lubrication water pump includes an operational mechanism that is driven at a predetermined fractional displacement amplitude or swing (of less than 100%, e.g., between approximately 10% 40% or approximately 15%-35% or approximately 25%) relative to or of the displacement amplitude or swing of the operational mechanism of the explosive composition precursor pump.

In accordance with a further aspect of the present disclosure, the stream merging assembly includes a Venturi-type lumen structure therein having a converging portion, a throat portion, a diverging portion, and an injector structure, wherein the converging portion configured to receive the explosive composition precursor or the water-lubricated explosive composition precursor, the throat portion is fluidically coupled to the converging portion, the injector structure, and the diverging portion, the injector structure is configured to receive the gassing agent stream, and the diverging portion is configured to output the combined stream.

In accordance with an additional aspect of the present disclosure, the system includes a multi-channel conduit or hose having a first lumen fluidically coupled to the explosive composition precursor line or the water-lubricated explosive composition precursor line and a second lumen fluidically coupled to the gassing agent line.

In accordance with a further aspect of the present disclosure, the system includes a conduit or hose coupling assembly having a body structure providing a first input lumen fluidically coupled to the explosive composition precursor line or the water-lubricated explosive composition precursor line, a second input lumen fluidically coupled to the gassing agent line, a first output lumen fluidically coupled to the first lumen of the multi-channel hose, and a second output lumen fluidically coupled to the second lumen of the multi-channel hose.

In accordance with a further aspect of the present disclosure, the first input of the stream merging assembly is fluidically coupled to the first lumen of the multi-channel hose, and the second input of the stream merging assembly is fluidically coupled to the second lumen of the multi-channel hose.

In accordance with a further aspect of the present disclosure, the outlet structure's dispensing/spray nozzle is fluidically coupled to a final conduit or hose segment that is fluidically coupled to the output of the stream merging assembly, wherein the combined stream flows along at least portions of the final conduit or hose segment between the output of the stream merging assembly and the outlet structure. In accordance with an additional aspect of the present disclosure, the final conduit or hose segment separates the outlet structure's dispensing/spray nozzle from the stream merging assembly by at least 1 m (e.g., between, 1.0-2.0 m, or 1.25-1.75 m, or 1.5 m).

In accordance with an additional aspect of the present disclosure, at least one of the final conduit or hose segment and the outlet structure includes at least one static mixer therein.

In accordance with an aspect of the present disclosure, a process or method for introducing, delivering, dispensing, or delivering an explosive composition into one or more boreholes (e.g., in a commercial blasting environment) includes: providing a system for introducing, dispensing, or delivering an explosive composition into a borehole (e.g., in accordance with one or multiple aspects of the present disclosure set forth above); and charging the borehole with the explosive composition by way of laterally dispensing or loading explosive the explosive composition onto the borehole sides or walls such that the thickness of the explosive composition delivered or applied onto the borehole sides or walls is intentionally varied with respect to the length of the borehole in a manner that produces a spatially periodic, spatially oscillating, or undulating explosive composition thickness along the sides or walls of the borehole along at least a portion of the borehole's length.

In accordance with an additional aspect of the present disclosure, the spatially periodic, spatially oscillating, or undulating explosive composition thickness along the sides or walls of the borehole correspond to or produce macro-scale compartments, cavities, or chambers and/or constrictions that are formed in a physically dispensed pattern of the explosive composition.

In accordance with another aspect of the present disclosure, the process or method includes intentionally producing a pulsatile, periodic, or oscillating flow rate of explosive composition precursor and/or explosive composition in portions of the system that reside external to the borehole. In accordance with a further aspect of the present disclosure, the pulsatile, periodic, or oscillating flow rate is correlated with the variation in the thickness of explosive composition delivered or applied onto the borehole sides or walls. In accordance with an additional aspect of the present disclosure, an average size, size distribution, spatial volume, or spatial volume distribution of the macro-scale compartments, cavities, or chambers and/or constrictions in the explosive composition is correlated with the pulsatile, periodic, or oscillating flow rate of explosive composition precursor and/or explosive composition in portions of the system that reside external to the borehole. In accordance with a still further aspect of the present disclosure, the pulsatile, periodic, or oscillating flow rate corresponds to the cyclical, periodic, or reciprocating operation of a positive displacement pump.

In accordance with an aspect of the present disclosure, a process or method for introducing, delivering, dispensing, or delivering an explosive composition into one or more boreholes (e.g., in a commercial blasting environment) includes: providing a system for introducing, dispensing, or delivering an explosive composition into a borehole (e.g., in accordance with one or multiple aspects of the present disclosure set forth above); and charging boreholes with explosive compositions by way of dispensing or loading explosive compositions using the system, wherein such explosive compositions include explosive composition physical patterns having bridge or constriction/in-fill/pinch regions alternatingly interposed with macro-void containing regions, wherein in a particular borehole each bridge or constriction/in-fill/pinch region includes an explosive composition that extends across or spans at least 40%-80% (e.g., at least 45%, 50%, 55%, 60%, 65%, 70%, or 75%) of the width of the particular borehole or across the entire width of the particular borehole, and wherein each macro-void containing region includes an explosive composition having a thickness range away from a wall of the particular borehole and a macro-void or cavity disposed therein, such that the macro-void or cavity prevents the explosive composition in the macro-void containing region from extending across or spanning the entire width of the particular borehole, and wherein relative to the width of the particular borehole each macro-void or cavity has a width that is at least 20% (e.g., at least 25%, 30%, 35%, 40%, 45%, or 50%) greater than the width of explosive composition gaps that may exist in bridge or constriction/in-fill/pinch regions directly adjacent to the macro-void or cavity.

In accordance with a further aspect of the present disclosure, such a process or method can include at least two of: intentionally loading (i) a first array of boreholes with a first explosive composition characterized by a first explosive composition physical pattern (e.g., having a first non-zero volumetric percentage or percentage range of macro-void content), for instance, based on a first set of rock properties or rock property values associated with the first array of boreholes; (ii) a second array of boreholes with a second explosive composition characterized by a second explosive composition physical pattern (e.g., having by a distinct second non-zero volumetric percentage or percentage range of macro-void content), for instance, based on a second set of rock properties or rock property values associated with the second array of boreholes; and (iii) a third array of boreholes with a third explosive composition that lacks explosive composition physical patterns, such that the volumetric macro-void content of the third explosive composition is zero, or the third array of boreholes intentionally omits or excludes any explosive composition having an explosive composition physical pattern, for instance, based on a third set of rock properties or rock property values associated with the third array of boreholes.

In accordance with an additional aspect of the present disclosure, a particular set of boreholes within a given array of boreholes (e.g., one or more boreholes within the aforementioned first array of boreholes or the second array of boreholes) can be loaded such the explosive compositions loaded into each borehole within the particular set of boreholes are characterized by or exhibit two or more distinct explosive composition physical patterns (e.g., corresponding to two different non-zero macro-void content percentages or percentage ranges) along the lengthwise or longitudinal axes of such boreholes.

In accordance with a further aspect of the present disclosure, the explosive composition physical patterns loaded into the boreholes have between 0%-30% (e.g., at least between approximately 0%-10%, 15%, 20%, or 25%), or between 1%-30% (e.g., at least between 1%-10%, 15%, 20%, or 25%) of their volumes occupied by macro-voids or cavities.

In accordance with an additional aspect of the present disclosure, the explosive composition physical patterns loaded into the boreholes are characterized by a relative bulk strength (RBS) between 50-150.

One or more of the foregoing aspects of the present disclosure can be combined, depending upon embodiment details.

### BRIEF DESCRIPTION OF THE DRAWINGS

One or more embodiments of the present invention are hereinafter described, by way of example only, with reference to the accompanying drawings in which:

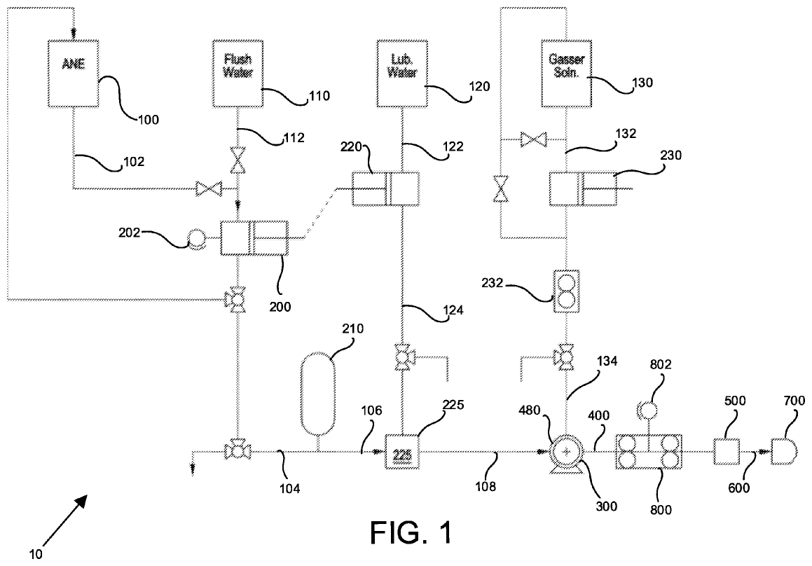

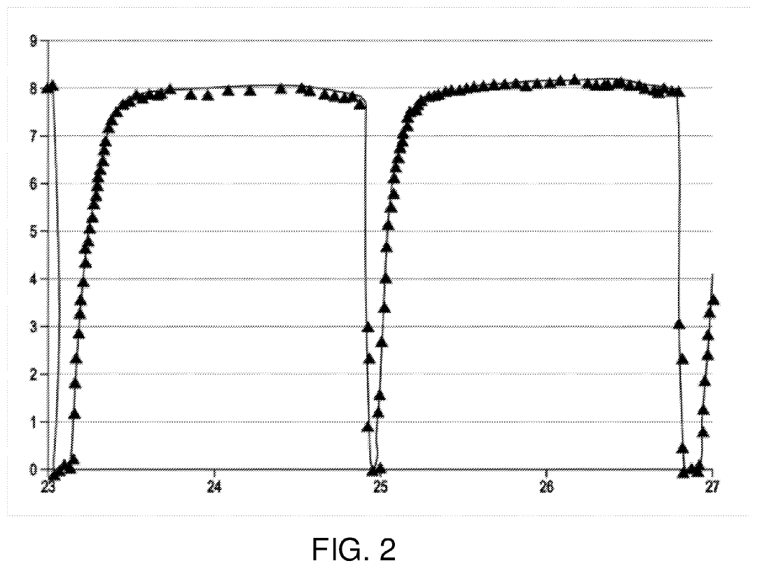

a. FIG. 1 is a block diagram of an explosive composition loading or delivery system in accordance with a representative embodiment of the present disclosure.

b. FIG. 2 is a graph showing an outlet pressure vs. time curve for an ammonium nitrate emulsion (ANE) pump in accordance with a representative embodiment of the present disclosure—pump outlet pressure in bar is on the Y axis and time in seconds is on the X axis.

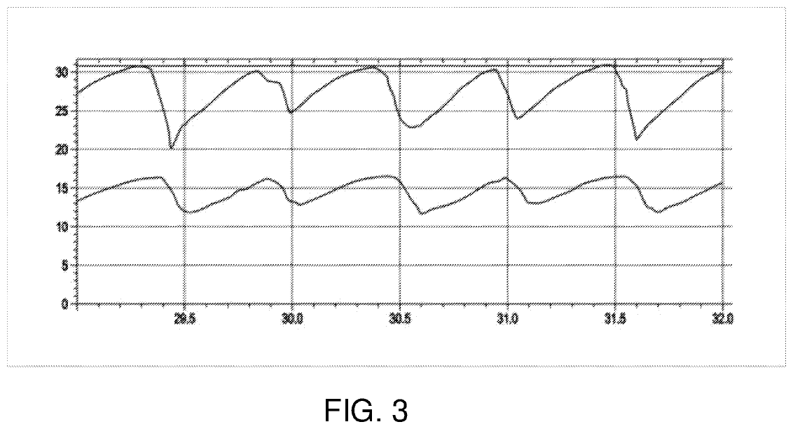

c. FIG. 3 is a graph including a first or top trace showing measured ANE pump outlet pressure vs. time, and a second or bottom trace showing measured dispensing/spray nozzle pressure vs. time—pressure in bar is on the Y axis and time is correspondingly on the X axis.

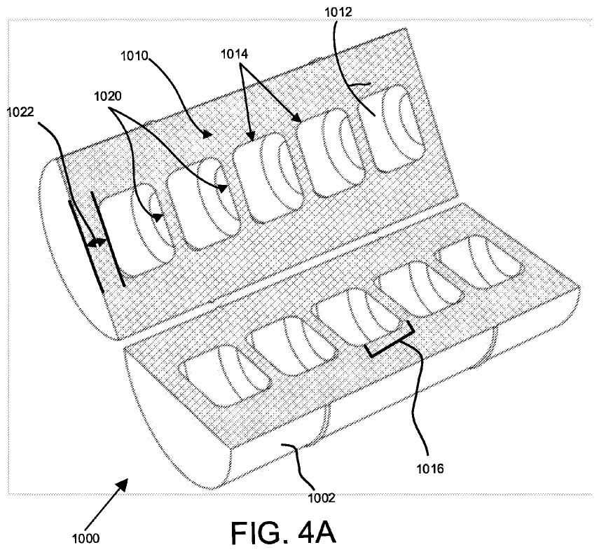

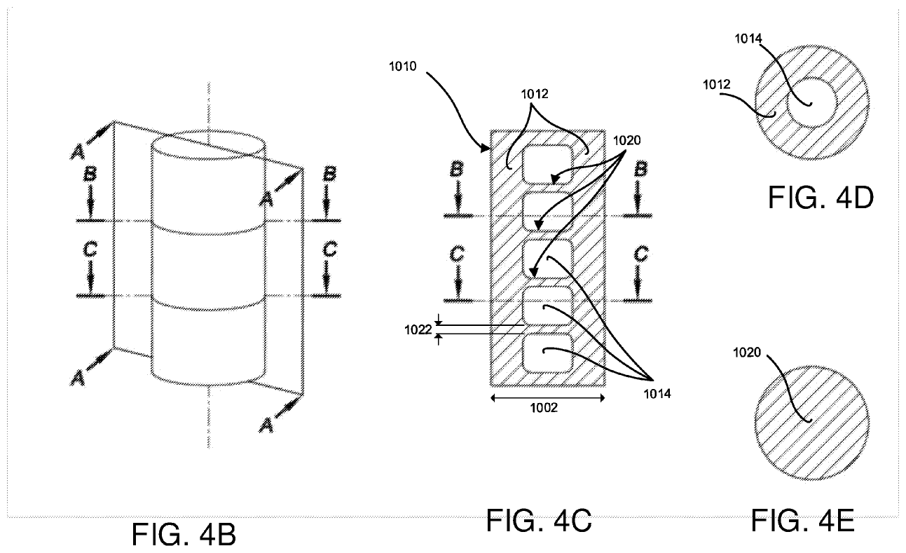

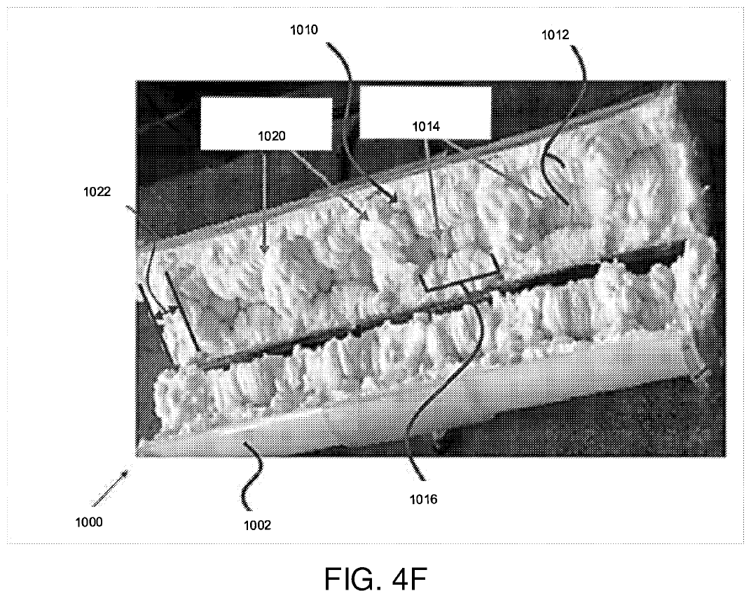

d. FIG. 4A is schematic illustration showing a representative explosive composition or gassed ANE physical pattern produced in portions of a representative model borehole structure, which could analogously be portions of an actual borehole, in accordance with an embodiment of the present disclosure.

e. FIG. 4B is a schematic illustration of an external perspective view of the physical pattern in FIG. 4A as if the representative model borehole structure were transparent.

f. FIG. 4C is a schematic illustration of a cross section along the axis of rotation A-A of the physical pattern in FIG. 4A.

g. FIG. 4D is a schematic illustration of a cross section B-B through the axis of rotation of the physical pattern in FIG. 4A, including through a macro-void or cavity of the physical pattern.

h. FIG. 4E is a schematic illustration of a cross section C-C through the axis of rotation of the physical pattern in FIG. 4A, including through a bridge or constriction/in-fill/pinch region of the physical pattern.

i. FIG. 4F is photograph showing a representative explosive composition or gassed ANE physical pattern produced in portions of a representative model borehole structure, which could analogously be portions of an actual borehole, in accordance with an embodiment of the present disclosure.

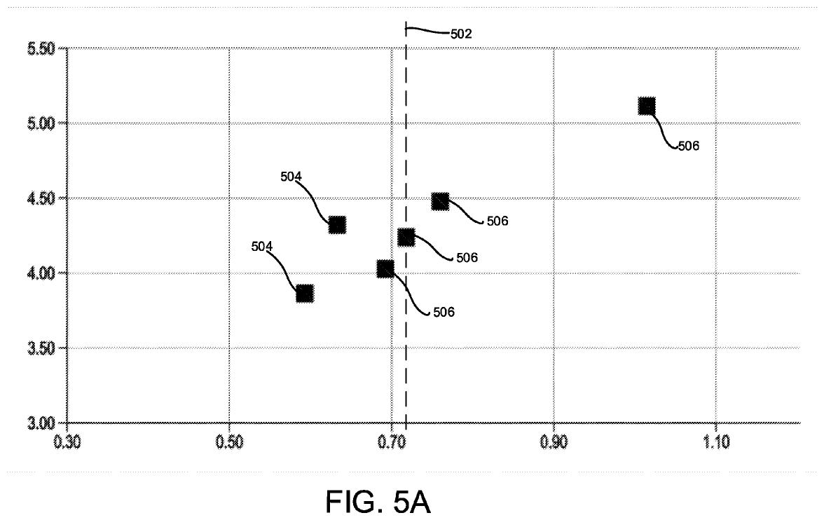

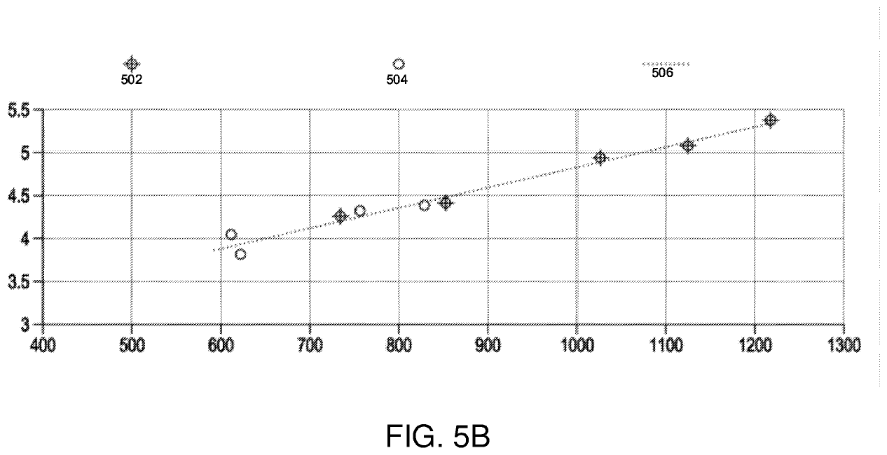

j. FIG. 5A is a first graph showing velocity of detonation (VOD) VOD as a function of bulk density for particular explosive composition or gassed ANE physical patterns loaded into representative model borehole structures, which could analogously be actual boreholes, in accordance with representative embodiments of the present disclosure—VOD in kilometers per second is on the Y axis and bulk density in grams per cc is on the X axis.

k. FIG. 5B is a second graph showing VOD vs. effective in-hole density, approximate or estimated macro-void percentage, and relative bulk strength (RBS) for particular explosive composition or gassed ANE physical patterns loaded into representative model borehole structures, which could analogously be actual boreholes, in accordance with representative embodiments of the present disclosure—VOD in kilometers per second is on the Y axis and effective in-hole density (including voidage) in kilograms per cubic meter is on the X axis.

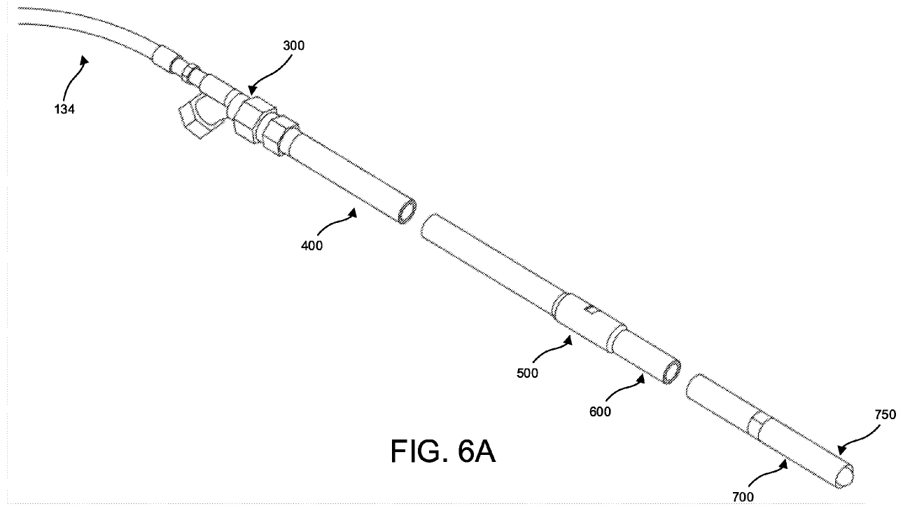

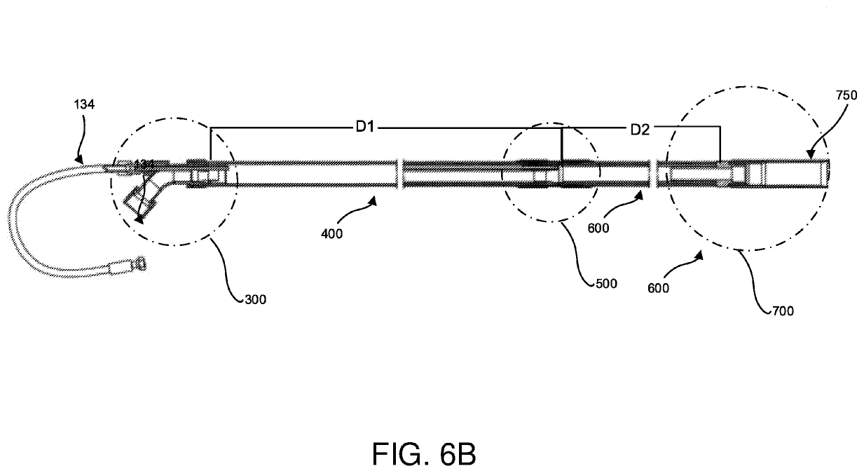

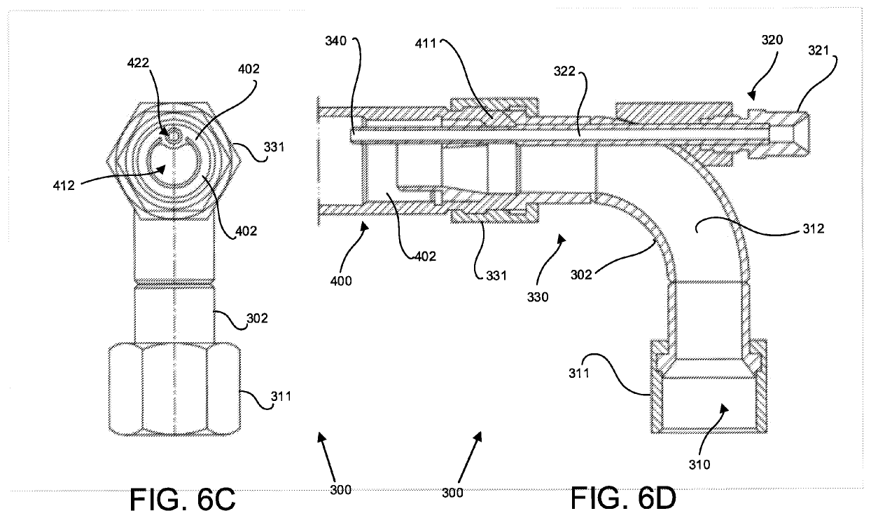

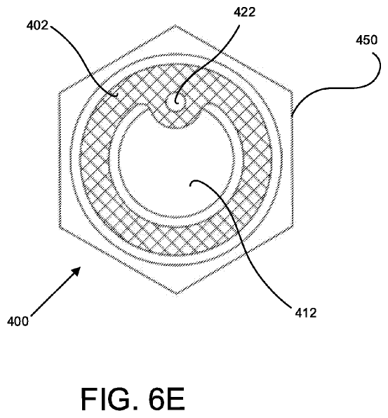

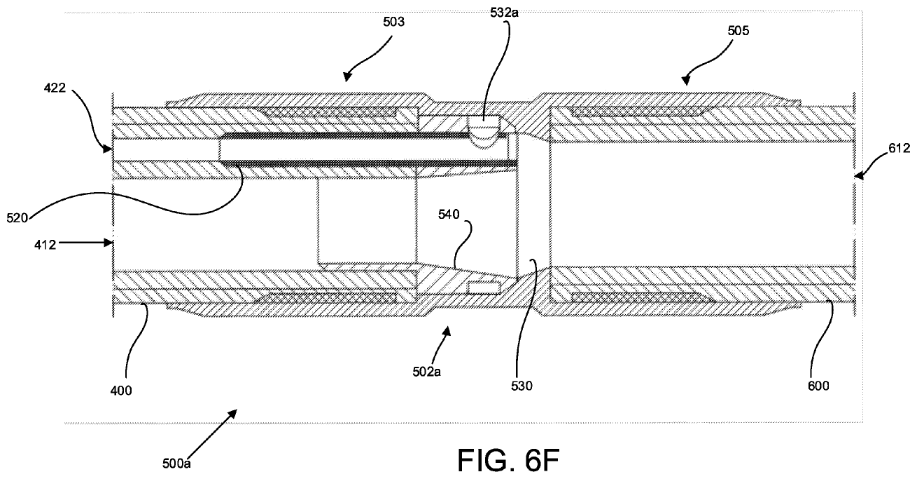

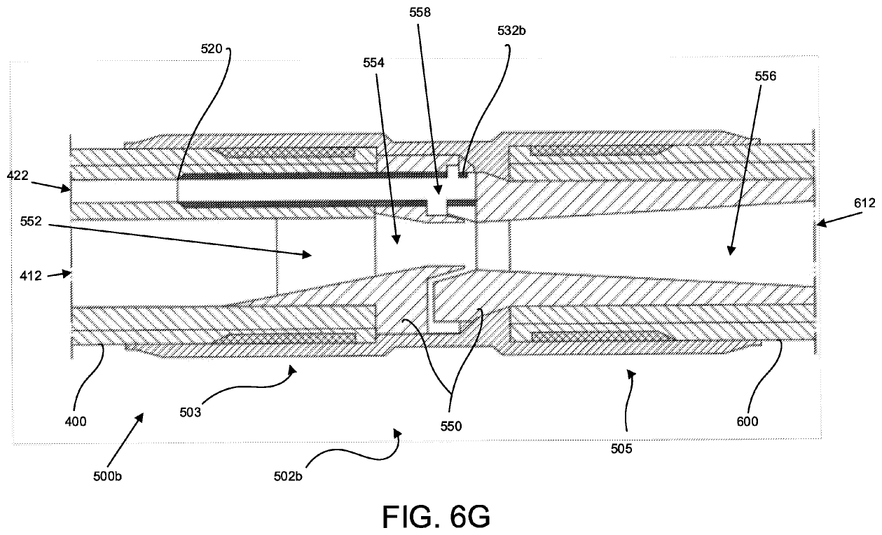

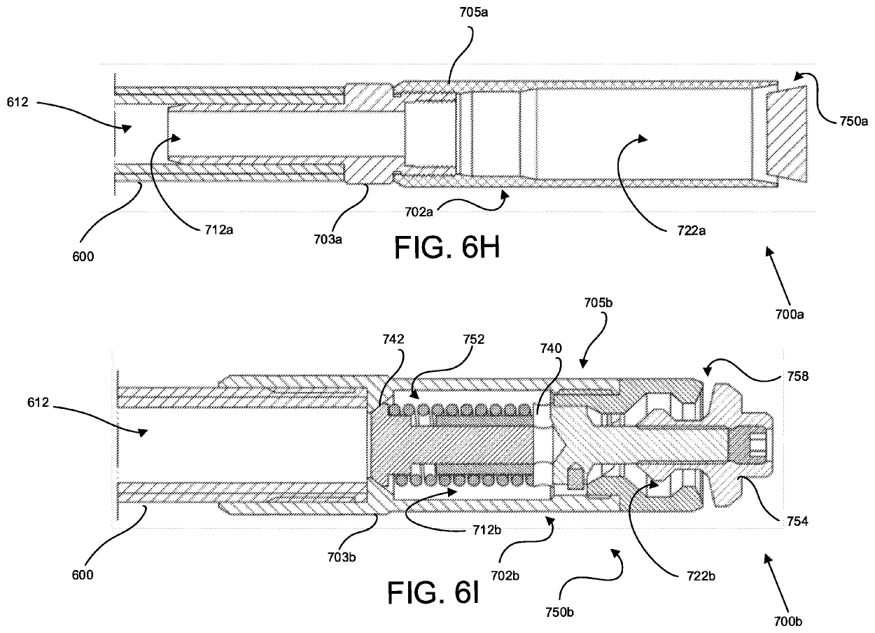

l. FIGS. 6A and 6B are schematic illustrations showing portions of a second gasser line, a hose coupling assembly, a dual channel hose, a stream merging structure, an additional or final hose segment, and a dispensing/spray nozzle in accordance with a representative embodiment of the present disclosure.

m. FIGS. 6C and 6D are schematic illustrations showing a frontal plan view and a cross-sectional view, respectfully, of a hose coupling assembly in accordance with a representative embodiment of the present disclosure.

n. FIG. 6E is a schematic illustration showing a cross-sectional view through a portion of a dual channel hose in accordance with a representative embodiment of the present disclosure.

o. FIG. 6F is a schematic illustration of a first stream merging assembly or structure in accordance with a representative embodiment of the present disclosure.

p. FIG. 6G is a schematic illustration of a second stream merging assembly or structure in accordance with a representative embodiment of the present disclosure, which includes a Venturi-type lumen structure therein.

q. FIGS. 6H and 6I are schematic illustrations of a first and a second conduit or hose outlet structure, respectively, in accordance with representative embodiments of the present disclosure.

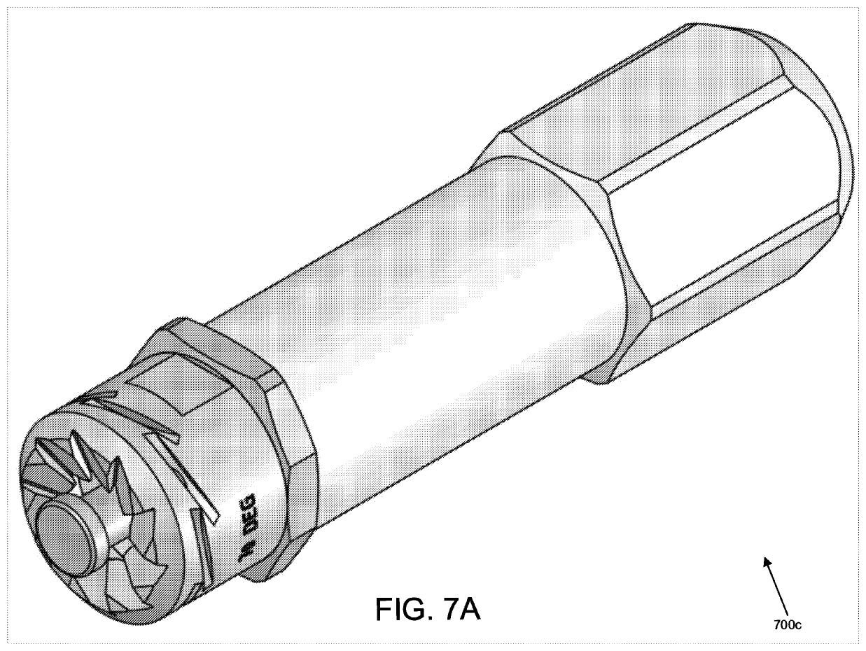

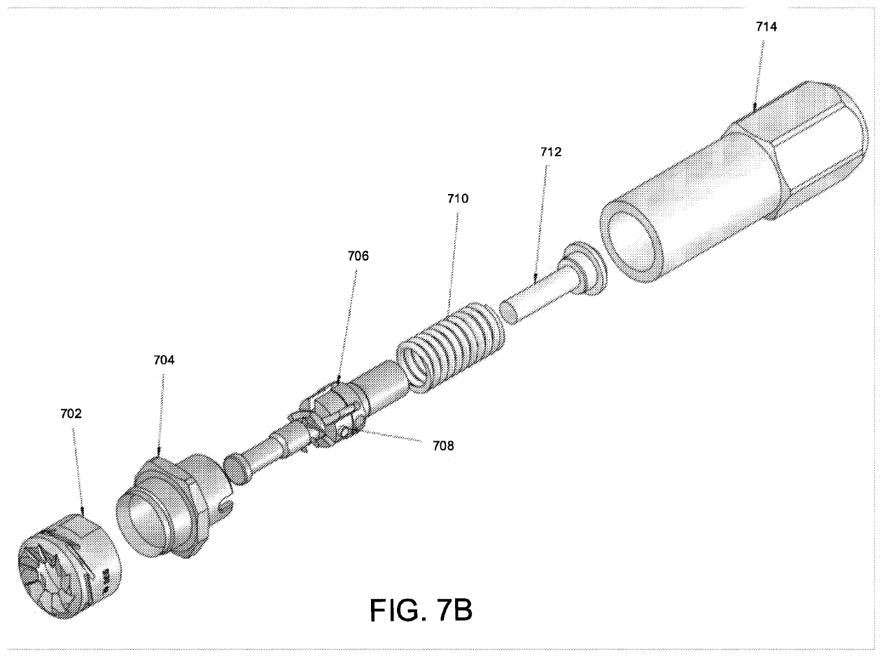

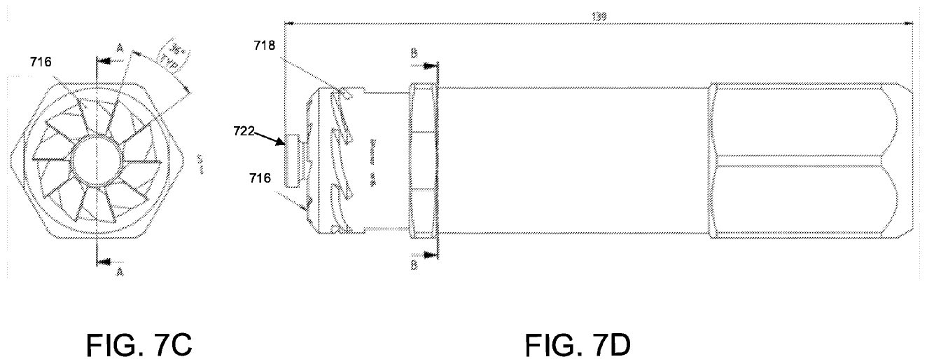

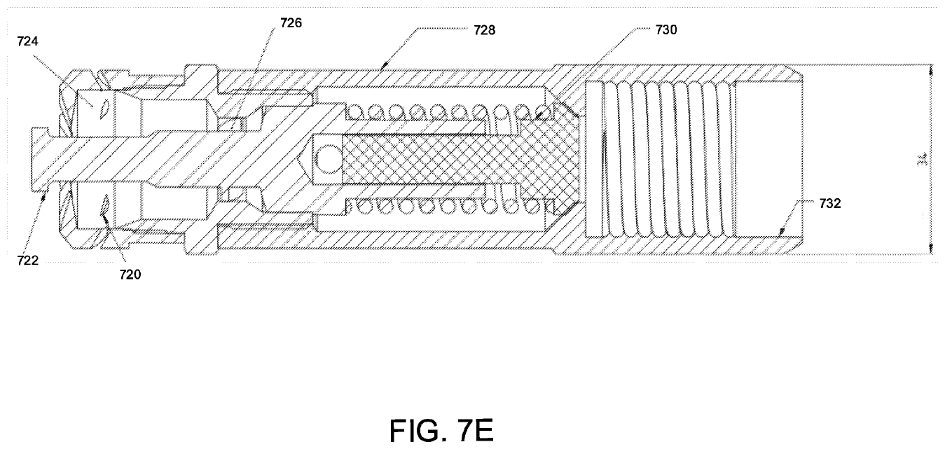

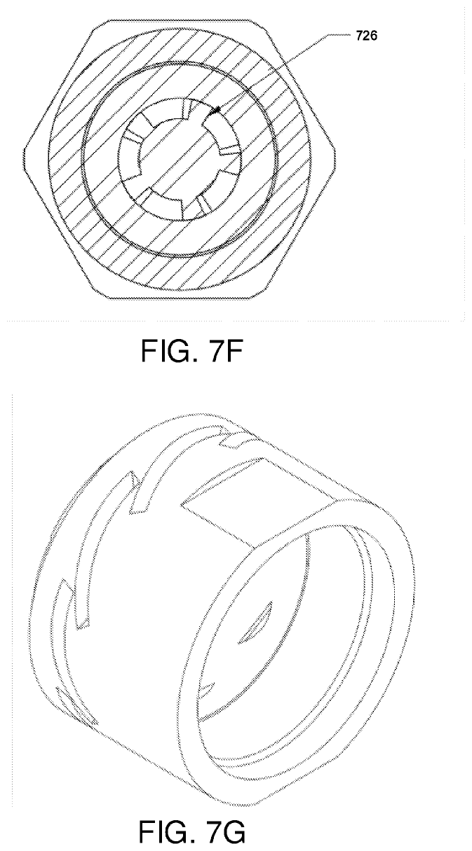

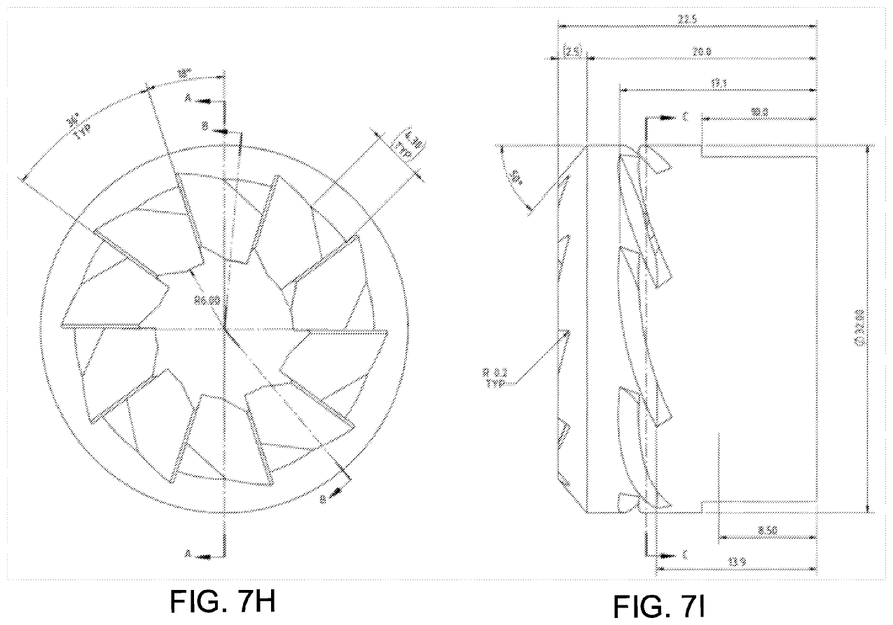

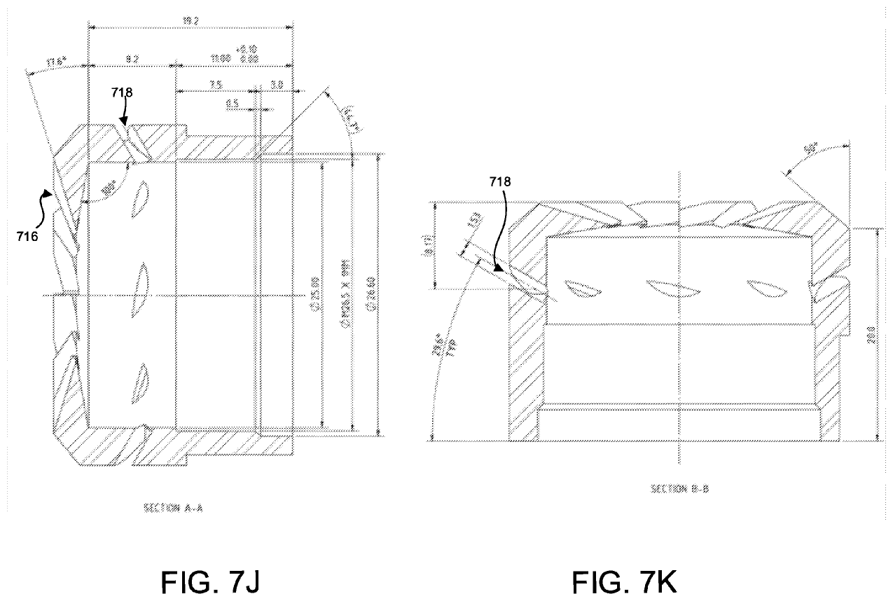

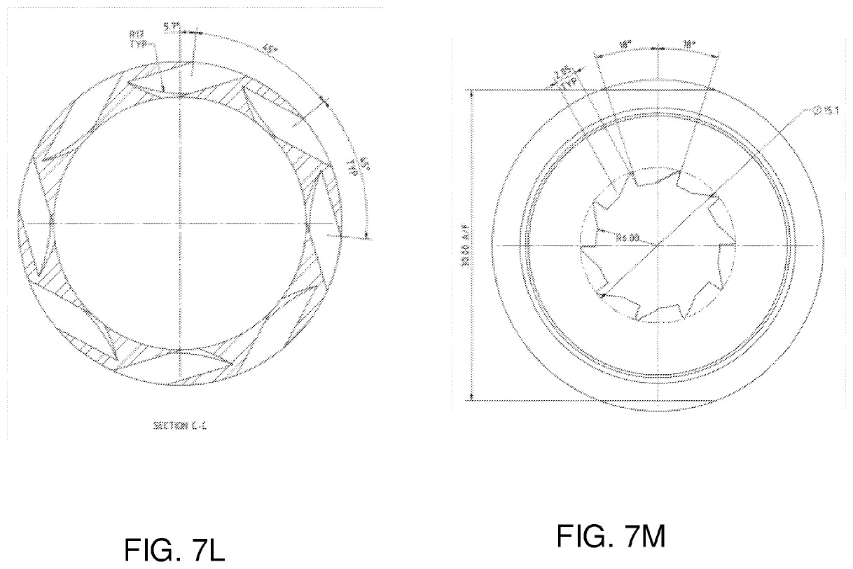

r. FIG. 7A is a schematic illustration of a front isometric view of a nozzle assembly forming a third conduit or hose outlet structure in accordance with representative embodiments of the present disclosure.

s. FIG. 7B is a schematic illustration of a front isometric exploded view of the nozzle assembly of FIG. 7A.

t. FIG. 7C is a schematic illustration of an outlet end view of the nozzle assembly of FIG. 7A.

u. FIG. 7D is a schematic illustration of a side view of the nozzle assembly of FIG. 7A.

v. FIG. 7E is a schematic illustration of the section A-A in FIG. 7C.

w. FIG. 7F is a schematic illustration of the section B-B in FIG. 7D.

x. FIG. 7G is a schematic illustration of a rear isometric view of a nozzle tip of the nozzle assembly of FIG. 7A.

y. FIG. 7H is a schematic illustration of an outlet end view of the nozzle tip of FIG. 7G.

z. FIG. 7I is a schematic illustration of a side view of the nozzle tip of FIG. 7G.

aa. FIG. 7J is a schematic illustration of the section A-A in FIG. 7H.

bb. FIG. 7K is a schematic illustration of the section B-B in FIG. 7H.

cc. FIG. 7L is a schematic illustration of the section C-C in FIG. 7I.

dd. FIG. 7M is a schematic illustration of a rear end view of the nozzle tip of FIG. 7G.

### DETAILED DESCRIPTION

### Interpretation

Throughout this specification, unless the context stipulates or requires otherwise, any use of word “comprise” or “includes”, and variations such as “comprises”, “comprising”, “includes”, or “including” imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). Thus, a set includes at least one element. In general, an element of a set can include or be one or more portions of a system, an apparatus, a device, a structure, an object, a process, a physical parameter, or a value depending upon the type of set under consideration.

Herein, reference to fluidic coupling can also implicitly indicate or encompass fluidic plus structural (e.g., mechanical or electro-mechanical) coupling such that apparatuses, devices, assemblies, and/or structures that are fluidically coupled can be associatively or correspondingly structurally coupled to facilitate or enable fluid flow therein, therealong, therethrough, therebetween, or therefrom (e.g., in one or more manners readily understood by individuals having ordinary skill in the relevant art).

The FIGS. included herewith show aspects of non-limiting representative embodiments in accordance with the present disclosure, and particular structural elements shown in the FIGs. may not be shown to scale or precisely to scale relative to each other. The depiction of a given element or consideration or use of a particular element number in a particular FIG. or a reference thereto in corresponding descriptive material can encompass the same, an equivalent, an analogous, categorically analogous, or similar element or element number identified in another or descriptive material associated therewith. The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” can indicate a percentage greater than or equal to 90%, for instance, 92.5%, 95%, 97.5%, 99%, or 100%. The term “approximately” can indicate an approximate numerical value or value range, e.g., within +/−20%, +/−15%, +/−10%, +/−5%, +/−2.5%, +/−2%, +/−1%, +/−0.5%.

Herein, reference to one or more embodiments, e.g., as various embodiments, many embodiments, several embodiments, multiple embodiments, some embodiments, certain embodiments, particular embodiments, specific embodiments, or a number of embodiments, need not or does not mean or imply all embodiments. Particular aspects of non-limiting representative embodiments in accordance with the present disclosure are described in detail hereafter.

### Overview

Aspects of the present disclosure relate to systems, apparatuses, and methods for conveying explosive composition constituents and charging (including delivering or loading) explosive compositions formed therefrom into boreholes, whereby (a) a flow rate of at least one sensitizing agent can be selectively established or varied, and/or (b) a flow rate of explosive composition precursor or intermediate material(s) can be or is intentionally varied in an oscillating manner, in association with the flow thereof within portions of a conduit structure toward a conduit outlet assembly.

Aspects of the present disclosure relate to systems, apparatuses, and methods for conveying explosive composition constituents and introducing, delivering, dispensing, or loading explosive compositions formed therefrom into boreholes. In accordance with further aspects of the present disclosure, explosive composition constituents can include one or more explosive composition precursor or intermediate materials (e.g., one or more blasting agents, such as an Ammonium Nitrate Emulsion (ANE) based material), and one or more sensitizing agents therefor. In multiple embodiments in accordance with the present disclosure, at least one of, or each of (a) a flow rate or function (e.g. a first flow rate or flow rate function) of at least one explosive composition precursor material can be or is intentionally varied (e.g., in an oscillating or pulsatile manner, possibly in a selective or selectable manner), and (b) a flow rate or function (e.g., a second flow rate or flow rate function) of at least one sensitizing agent can be selectively or selectably established or varied while such explosive composition constituents flow within portions of a conduit structure toward an outlet assembly or structure associated with the conduit structure, such that:
(i) explosive composition constituents can be conveyed and mixed to produce explosive compositions having selectably or selectively (e.g., adjustably or programmably) established or varied energies relative to an effectively increased or wider (e.g., significantly or surprisingly wider) explosive composition energy range than previously available, thus providing greater flexibility in blast design parameters; and
(ii) such explosive compositions can be delivered into boreholes in a manner that facilitates (e.g., significantly or surprisingly) the maintenance of in-hole explosive composition integrity and the predictability of in-hole explosive composition detonation properties, thereby increasing the likelihood of reliably achieving intended blast design objectives or outcomes.

The explosive composition delivered into the borehole that forms the physical pattern is generally selected to have a target effective yield stress of at least 300 Pascal, at least 325 Pascal, or at least 350 Pascal, or at least 370 Pascal. This effective yield stress may be equivalent to a commercially available uphole loading formulation. Effective yield stress (tau_E) is a measure of a product's force of adhesion to the borehole wall, thus a quantification of wall effects. The target minimum effective yield stress (tau_E_min), in Pascal, can be determined for each application based on the borehole diameter (D) in meters, the borehole angle from the vertical (theta, which is zero when vertical) and explosive composition density (rho, which is the density of the emulsion with the sensitizing agents if present) in grams/cc, e.g., tau_E_min is substantially equal to the magnitude of D/4 (rho.g.cos(theta)), where g is acceleration due to gravity in meters per second. The target minimum effective yield stress is selected to provide an adhesion force that is greater than the weight force.

For purpose of brevity and to aid understanding, in the description that follows, explosive composition precursor materials are considered to be ANE-based explosive composition precursor materials, and equipment that is configurable or configured for carrying, handling, or conveying explosive composition precursor materials is correspondingly described in the context of ANE-based explosive composition precursor materials or chemistries. Notwithstanding, embodiments in accordance with the present disclosure are not limited to ANE-based explosive composition precursor materials or chemistries. Hereafter, an ANE-based explosive composition precursor material can simply be referred to as ANE.

Moreover, various portions of the description that follows describe the sensitization of an explosive precursor material such as ANE by way of the addition of one or more chemical gassing agents thereto, and the mixing (e.g., thorough mixing) of such chemical gassing agent(s) with the ANE. Notwithstanding, embodiments in accordance with the present disclosure are not limited to sensitization by way of chemical gassing agents. For instance, embodiments in accordance with the present disclosure can additionally or alternatively sensitize an explosive precursor material such as ANE by way of solid or already-formed sensitizing agents, for instance, glass or plastic microballoons, expanded polystyrene beads or microbeads, or non-chemically formed (e.g., mechanically generated) gas bubbles. For purpose of brevity, a chemical gassing agent may simply be referred to as a gassing agent in the description that follows.

### Aspects of Representative Systems, Apparatuses, and Devices

FIG. 1 is a block diagram of a system 10 for conveying explosive composition constituents and delivering explosive compositions formed therefrom into boreholes in accordance with an embodiment of the present disclosure. In various embodiments, the system 10 is configurable or configured for handling or conveying one or more explosive composition precursor materials and one or more gassing agents therefor, and delivering or dispensing an initially-forming or initially-formed explosive composition (e.g., an explosive composition in which chemical gassing reactions are occurring after thorough mixing of an explosive composition precursor material with a gassing agent) into blastholes, as further detailed below. In a representative implementation, the system 10 can form a portion of, be included or associated with, or be a movable, (trans)portable, or mobile explosive composition delivery platform or vehicle, for instance, based on an Orica MaxiLoader platform (Orica International Pte Ltd, Singapore).

In view of the foregoing, in various embodiments the system 10 includes at least one ANE reservoir or tank 100 that can carry ANE (e.g., a particular or predetermined volume of ANE), for instance, commercially available Orica ANE 230 (Orica International Pte Ltd, Singapore). The ANE tank 100 includes an outlet or output that is fluidically coupled by way of a first ANE conduit or line 102 to an inlet side or input of an explosive precursor pump in the form of an ANE pump 200. The ANE pump 200 provides a discharge side, outlet, or output that is fluidically coupled to a second ANE conduit or line 104. Hence, the ANE pump 200 is configurable or configured for pumping ANE from the first ANE line 102 into the second ANE line 104.

The ANE pump 200 includes an operational mechanism that functions in a cyclical, oscillating, periodic, or reciprocating manner such that the ANE pump 200 cyclically generates or discharges a stream of ANE having a flow rate that varies as a function of time (e.g., cyclically or periodically) within each single cycle or period of the ANE pump's operational mechanism. More particularly, in various embodiments the ANE pump 200 includes or is a positive displacement pump, for instance, a high pressure piston-based pump, such as a double acting single piston/simplex metering pump (e.g., an Orica MaxiPump MK2 or MK3 available from Orica International Pte Ltd, Singapore) which repeatedly or recurrently discharges ANE in a cyclical or periodic manner relative to or during each complete piston stroke period, for instance, in a manner that can be represented or characterized by a corresponding ANE pump discharge curve. A representative ANE pump discharge curve for a double acting single piston ANE metering pump 200, in this case and Orica MaxiPump, is shown in FIG. 2, where a complete piston stroke period corresponds to reciprocation of a hydraulic cylinder in a manner readily understood by individuals having ordinary skill in the relevant art, and where the ANE metering pump 200 is operating at approximately 15 cycles per minute. It can be noted that during borehole loading operations, such a pump can be operated at approximately 60 cycles per minute, or one or more other cycle rates depending upon embodiment details and/or borehole loading objectives/intended in-hole explosive composition or gassed ANE variation(s). The flow rate of the explosive precursor, e.g., ANE, varies based on an amount of explosive composition precursor per pump stroke of the ANE pump 200, e.g., substantially 600 or 650 grams.

It can be noted that various embodiments in accordance with the present disclosure utilize a positive displacement pump configured for intentionally providing an ANE flow characterized by an oscillatory or pulsed flow rate during each complete cycle or period of the ANE pump's operational mechanism (e.g., piston), rather than utilizing or only utilizing a progressive or progression cavity pump or a residual pressure application vessel as commonly known or conventionally used to generate an essentially constant flow of ANE (e.g., with minimal, negligible, or essentially no ANE flow rate oscillation or pulsation) during normal operation.

The ANE pump 200 is coupled to a first encoder 202, such as a first programmable speed encoder (e.g., a Balluff LVDT encoder strip speed encoder) that is configurable or configured for controlling the speed at which the ANE pump's operational mechanism (e.g., the piston in this representative example) is driven, and hence the operational mechanism's cyclical frequency. For each different (e.g., beyond of the range of speed control error) speed at which the ANE pump's operational mechanism is driven, the time required for a single complete cycle of the ANE pump's operational mechanism to occur differs, and a corresponding different quantity of ANE is output by the ANE pump 200 with respect to a given time interval, such as one second or one minute, as will be readily understood by individuals having ordinary skill in the relevant art.

Referring again to FIG. 1, the input of the ANE pump 200 can also be fluidically coupled to a flush water reservoir or tank 110 by way of a flush or purge water conduit or line 112, such that the ANE pump 200, one or more portions of the second ANE line 104, and other downstream portions of the system (including down to a dispensing/spray nozzle 750, shown in FIG. 6) can be flushed or purged, in a manner readily understood by individuals having ordinary skill in the relevant art.

The second ANE line 104 couples the ANE pump 200 to an inlet or input of a pulsation or pulse dampener 210, which provides an outlet or output fluidically coupled to a third ANE conduit or line 106. The pulsation dampener 210 is configurable or configured for reducing and tuning the peak pressure as well as the pressure swing or variation corresponding to the output of the ANE pump 200 (e.g., the maximum-to-minimum ANE pump output pressure difference or swing during steady state operation), and hence reducing and tuning the oscillatory or pulsatile variation in ANE flow rate (e.g., the maximum-to-minimum or peak-to-trough oscillatory or pulsed flow rate value difference or swing) corresponding to each cycle or period of the ANE pump's operational mechanism (e.g., piston). In multiple embodiments, the pulsation dampener 210 is configurable or configured to provide at its output an oscillatory or pulsed ANE flow having a peak-to-trough flow rate amplitude or value difference or swing with respect to a single cycle or period of the ANE pump's operational mechanism (e.g., piston) which is between approximately 60%-100% (e.g., depending upon embodiment details approximately 65%-100%, 70%-100%, 75%-100%, 80%-100%, 85-100%, or 90-100%) of that produced, measurable, or measured at the output the ANE pump 100. In a representative implementation, the pulsation dampener 210 can be pre-charged to approximately 17-20 bar of pressure (e.g., with compressed dry nitrogen or compressed dry air).

FIG. 3 is a graph showing a representative pressure variation or swing measured at the output of the ANE pump 210 (top trace) during each of multiple individual cycles or periods of the ANE pump's operational mechanism (e.g., piston) compared to the pressure variation or swing measured at a terminal spray/dispensing nozzle 750 of the system 10 by which explosive composition or gassed ANE is delivered into a borehole (bottom trace) during each of these ANE pump operational mechanism (e.g., piston) cycles or periods. In such a representative example, the pressure measured at the spray/dispensing nozzle 750 ranges between approximately 12 (Pmin) and 16 (Pmax) bar, giving a pressure swing or ΔP at the spray/dispensing nozzle of approximately 4 bar. If the mean pressure at the spray/dispensing nozzle 750 is taken to be approximately 14 bar, then on a percentage basis the pressure range, swing, or ΔP at the spray/dispensing nozzle is approximately 29% of this mean pressure.

The system 10 further includes a lubrication water reservoir or tank 120 fluidically coupled to a water lubrication pump 220 by way of a first lubrication water conduit or line 122, which is provided to an input of the water lubrication pump 220. The water lubrication pump 220 is configurable or configured to generate a pressurized flow or stream of lubrication water at an output thereof, which is provided to a lubrication water injector 225 by way of a second lubrication water conduit or line 124. The water lubrication pump 220 is driven cooperatively or coincident with the ANE pump 200, typically at a predetermined fractional operational mechanism (e.g., piston) displacement amplitude or swing relative thereto (e.g., approximately 10%-40%, or approximately 15%-35%., or approximately 25% of the piston displacement amplitude or swing of the ANE pump 200).

The lubrication water injector 225 has a first input fluidically coupled to the output of the pulsation dampener 210, and thus receives the oscillatory or pulsed ANE flow output thereby; and a second input fluidically coupled to the output of the lubrication water pump 220, and thus receives the pressurized flow of lubrication water output thereby. The lubrication water injector 225 is configurable or configured to produce a water-lubricated ANE stream at an output thereof, where the water-lubricated ANE stream has or is formed as an inner, internal, core, or central ANE plug with a peripheral or outer layer of lubrication water annularly surrounding the core ANE plug, such that the core ANE plug and the lubrication water annulus flow in a cooperative, simultaneous, or unified manner from the output of the lubrication water injector 225. The output of the lubrication water injector 225 feeds the water-lubricated ANE stream into a water-lubricated ANE conduit or line 108. Thus, it can be noted that along the length of the water-lubricated ANE line 108, the quantity, mass, or volume of ANE in the core ANE plug within the water-lubricated ANE line 108 varies in an oscillating or pulsating manner that is correlated with the oscillating or pulsating ANE flow rate at the output of the pulsation dampener 210, which itself corresponds to the oscillating or pulsating ANE flow rate during each of multiple individual ANE pump operational mechanism (e.g., piston) cycles or periods.

The system 10 additionally includes a chemical gassing agent reservoir or tank 130 configurable or configured to carry a particular or predetermined volume of a chemical gassing agent (e.g., a sodium nitrite and/or other nitrite solution and/or other constituents or components), and which has an output fluidically coupled to an input of a chemical gassing agent pump 230 by way of a first gasser solution conduit or line or first gasser conduit or line 132. The chemical gassing agent pump 230 is configurable or configured to provide at an output thereof a stream of chemical gassing agent or a gassing agent stream in accordance with a selective or selectable (e.g., adjustable or programmable) flow rate to a second gasser solution conduit or line 134 or second gasser conduit or line 134, where the second gasser line 134 is fluidically coupled to a flow meter/controller 232 configured to measure or monitor the flow of chemical gassing agent in the second gasser line 134, and facilitate or enable the selective or selectable (e.g., adjustable or programmable) regulation or control thereof, for instance, such that the gassing agent stream can be provided at a constant flow rate or a varying or variable flow rate, or in accordance with a flow rate function.

As further detailed below, the water-lubricated ANE stream flowing in the water-lubricated ANE line 108 and the gassing agent stream flowing in the second gasser line 134 are provided to a first input and a second input, respectively, of a conduit or hose coupling assembly 300, which is fluidically coupled to a multi-channel conduit or hose 400 (e.g., a dual channel hose 400) by which the water-lubricated ANE stream and the gassing agent stream flow in a contemporaneous or concurrent yet physically segregated, separated, or isolated manner. In some embodiments, the water-lubricated ANE line 108 can be fluidically coupled to a first or input-side junction (e.g., a first rotary junction) of a hose reel 480, and fluidically fed to or through a second or output-side junction (e.g., a second rotary junction) of the hose reel 480; and the hose coupling assembly 300 can be fluidically coupled to the second or output-side junction (e.g., a second rotary junction) of the hose reel 480, such that the multi-channel hose 400 can be wound around and unwound from the hose reel 480. In other embodiments, a hose reel 480 is not present or not utilized.

After flowing through the dual channel hose 400 (e.g., across or along a maximum length of the dual channel hose 400), the physically segregated, separated, or isolated water-lubricated ANE stream and gassing agent stream are combined (and typically well or uniformly mixed) by way of a stream merging, combination, or unification assembly or structure 500 into a explosive composition stream or gassed ANE stream, such that sensitizing voids (or “micro-voids”) can be, are being, and/or have been generated in the explosive composition stream or gassed ANE stream once it has been formed (e.g., depending upon the reaction rate kinetics of a chemical gassing reaction). In at least some embodiments, the stream merging assembly or structure 500 is fluidically coupled to an additional or final conduit or hose segment 600, such that explosive composition stream or gassed ANE stream further flows through the additional or final conduit or hose segment 600. The explosive composition stream or gassed ANE stream is subsequently dispensed, output, or ejected from a conduit or hose outlet structure 700 (e.g., to which the additional or final conduit or hose segment 600 is fluidically coupled), which typically includes a dispensing/spray nozzle 750 at a terminal portion or end thereof.

In various embodiments, the dispensing/spray nozzle 750 is configured for dispensing the explosive composition stream or gassed ANE stream in a radial or circumferential manner around the periphery of the dispensing/spray nozzle 750 onto the sides or walls of a borehole, at a lateral angle or across a lateral angle range (e.g., where directly lateral corresponds to perpendicular to the borehole walls, or 90 degrees offset from the lengthwise or longitudinal borehole axis), in a manner readily understood by individuals having ordinary skill in the relevant art. In some embodiments, the dispensing/spray nozzle 750 is configured to output explosive composition or gassed ANE ejected therefrom at a lateral angle of approximately 20 degrees offset from directly lateral along a vector direction opposite to an outlet structure or final hose segment retraction or withdrawal vector direction; or analogously approximately 70 degrees offset from the lengthwise or longitudinal axis of a borehole in a vector direction opposite to the outlet structure or final hose segment retraction or withdrawal vector direction. In a number of embodiments, the dispensing/spray nozzle 750 is configured to direct explosive composition or gassed ANE ejected therefrom across a lateral angle range of approximately 15-25 degrees, or about 20 degrees, offset from directly lateral in a vector direction opposite to an outlet structure or final hose segment retraction or withdrawal vector direction; or analogously approximately 60-80 degrees or approximately 65-75 degrees offset of the lengthwise or longitudinal axis of a borehole, in a vector direction opposite to the outlet structure or final hose segment retraction or withdrawal vector direction.

One or more static mixers can optionally be disposed between the stream merging assembly or structure 500 and a portion of the outlet structure 700, such as the dispensing/spray nozzle 750. In at least some embodiments, depending upon embodiment details, the stream merging assembly or structure 500 is disposed at least approximately 0.25 m-5 m, or between 0.5-5.0 m (e.g., at least 1.0 m, and possibly further such as up to approximately 2.0, 2.5, 3.0, 3.5, 4.0, 4.5, or 5 m), or between approximately 1.25-1.75 m (e.g., about 1.5 m) away from a particular portion of the outlet structure 700, such as the terminal end of the dispensing/spray nozzle 750, as further described below. Such an arrangement or relative positioning of the stream merging assembly or structure 500, the additional or final conduit or hose segment 600, and the outlet structure 700 can ensure that the mixing of the core ANE plug with gassing agent is thorough and (more) uniform after their respective separate or segregated streams within the dual channel hose 400 are merged into a combined, unified, or single stream by way of the stream merging assembly or structure 500. It can be noted that this type of arrangement or relative positioning of the stream merging assembly 500 relative to the outlet structure 700 introduces or injects the gassing agent stream into the water-lubricated ANE stream away from the terminal portion or distal end of the outlet structure 700 (e.g., away from the terminal portion or distal end the dispensing/spray nozzle 750). Hence, rather than “end of hose gassing” this type of arrangement or relative positioning of the stream merging assembly 700 relative to the outlet structure 700 (and the additional or final conduit or hose segment 600) can be referred to as “in-hose gassing”.

Because the water-lubricated ANE stream carries or contains a core ANE plug characterized by or exhibiting an oscillating or pulsating ANE quantity, mass, or volume along the length of the water-lubricated ANE stream, the amount of explosive composition or gassed ANE that is output, dispensed, or ejected from the outlet structure 700 per standard unit of time (e.g., 1 second or 1 minute) oscillates or pulsates in a manner correlated with such oscillation or pulsation. Consequently, the thickness of explosive composition or gassed ANE that is dispensed or sprayed onto borehole walls correspondingly varies as a function of time.

Several embodiments include a conduit or hose deployment/withdrawal or pusher/puller apparatus 800 configurable or configured for controllably extending and retracting the additional or final conduit or hose segment 600 and the outlet structure 700, plus possibly portions of the dual channel hose 400. The hose pusher/puller apparatus 800 is coupled to a second encoder 802, such as a second programmable speed encoder, that is configurable or configured for controlling the rate at which the additional or final conduit or hose segment 600 and the outlet structure 700, plus possibly portions of the dual channel hose 400, are retracted or withdrawn from a borehole as the explosive composition or gassed ANE is dispensed from the outlet structure 700. This retraction rate can be selectively or selectably established in a cooperative or coordinated manner with respect to the oscillating or pulsating amount of explosive composition or gassed ANE that is dispensed from the outlet structure 700 per standard unit of time to thereby intentionally and selectively or selectably facilitate the production of physical patterns of explosive composition or gassed ANE along the borehole walls, where such physical explosive composition or gassed ANE physical patterns include distinguishable or distinct explosive composition or gassed ANE regions or zones that are intentionally repeated or recurrently, cyclically, or periodically disposed along at least portions of the borehole length or longitudinal axis, and where different or successive (e.g., directly adjacent) explosive composition or gassed ANE regions or zones are characterized by or exhibit different thickness profiles and/or contours along the borehole walls, such as shown in FIG. 4 and described in greater detail hereafter.

FIG. 4A is a schematic illustration (and FIG. 4F is a photograph) showing portions of a representative explosive composition with a physical pattern (e.g., gassed ANE) produced in accordance with an embodiment of the present disclosure, and which is disposable along borehole walls by way of a system 10 such as shown in FIG. 1. More particularly, FIG. 4A shows portions of a representative model borehole structure 1002 (e.g., a polymer tube having a 97 mm diameter) that is approximately bisected down a lengthwise or longitudinal segment thereof after being loaded with an explosive composition or gassed ANE in accordance with an embodiment of the present disclosure (e.g., by way of the system of FIG. 1), where chemical gassing reactions have essentially completed or entirely completed. It can be noted that the representative model borehole structure 1002 shown in FIG. 4A could instead be a particular portion, segment, or section of an actual borehole.

An explosive composition or gassed ANE physical pattern 1000 such as that shown in FIGS. 4A-4F includes a plurality of distinguishable or distinct explosive composition or gassed ANE regions 1010, 1020 that are recurrently disposable or disposed along a borehole wall, e.g., in a sequentially alternating or periodic manner. As indicated in FIG. 4, in multiple embodiments the explosive composition or gassed ANE physical pattern 1000 includes an alternating sequence of:
a. macro-void containing regions 1010, each of which includes or is formed as a three dimensional (3D) volume of explosive composition or gassed ANE having (i) a thickness or thickness range of wall material 1012 on, over, or along a lengthwise portion of the wall of the representative model borehole structure 1002 or an actual borehole; and (ii) a macro-void or cavity 1014 approximately centrally disposed therein along its length or depth and which is free of explosive composition or gassed ANE, such that the explosive composition or gassed AND does not extend across the macro-void or cavity 1014 and hence does not extend across the entire width of the representative model borehole structure 1002, and which in an actual borehole would analogously not extend across the entire width of the borehole; and
b. bridge or constriction/in-fill/pinch regions 1020, each of which is formed as a 3D volume of explosive composition or gassed ANE having a particular length or depth or length or depth range 1022 along a lengthwise portion of the representative model borehole structure 1002 or an actual borehole, and which extends significantly across (e.g., at least approximately 40%-80%, or at least approximately 45%, 50%, 55%, 60%, 65%, 70%, or 75% of) the distance across or width of the representative model borehole structure 1002, or across the entire width of the representative model borehole structure 1002, and which in an actual borehole would analogously extend significantly across (e.g., at least approximately 40-80%, or at least approximately 45%, 50%, 55%, 60%, 65%, 70%, or 75% of) the distance across or width of the borehole, or across the entire width of the borehole, in a manner that segregates or separates adjacent macro-void containing regions 1010 from each other.

Depending upon blast design/intended blast outcome objectives, in some embodiments, bridge or constriction/in-fill/pinch regions 1020 may not or need not extend entirely across the width of one or more boreholes having explosive composition or gassed ANE physical patterns 1000 therein. That is, in some embodiments bridge or constriction/in-fill/pinch regions 1020 are intentionally produced such that they do not extend across the entire width of the borehole(s), and hence each of such bridge or constriction/in-fill/pinch regions 1020 intentionally has a gap (e.g., a macro-gap) therein or thereacross with respect to borehole width. In such embodiments, each macro-void or cavity 1014 has a width that is significantly greater, for instance, at least 20% (e.g., at least approximately 25%, 30%, 35%, 40%, 45%, or 50%) greater than the width of explosive composition gaps (e.g., macro-scale gaps or macro-gaps) that exist in the bridge or constriction/in-fill/pinch regions directly adjacent to the macro-void or cavity 1014. Stated analogously, gaps (e.g., macro-scale gaps or macro-gaps) in each of such bridge or constriction/in-fill/pinch region 1020 are significantly smaller or narrower than the width of the macro-voids or cavities 1014 that are directly adjacent to the bridge or constriction / in-fill/pinch region 1020, for instance, by at least approximately 20% (e.g., at least approximately 25%, 30%, 35%, 40%, 45%, or 50%).

Thus, depending upon embodiment details and/or blast design/blast outcome objectives, along at least portions of a borehole an explosive composition or gassed ANE physical pattern 1000 delivered into the borehole (e.g., laterally delivered onto the sides or walls of the borehole, in a manner set forth herein) can intentionally be characterized by or exhibit a spatially periodic, spatially oscillating, or undulating explosive composition or gassed ANE thickness along the walls of the borehole (e.g., relative to the lengthwise or longitudinal axis of the borehole). Hence, along at least portions of a borehole's length an explosive composition or gassed ANE physical pattern 1000 can be characterized by or exhibit a spatially oscillating or periodic series of macro-scale compartments, cavities, or chambers and/or constrictions that are formed by way of intentionally varying the thickness of the explosive composition or gassed ANE delivered or applied to the borehole sides or walls during the lateral delivery or application of the explosive composition or gassed ANE thereon. This spatially oscillating or periodic manner can be correlated with or correspond to at least the oscillatory or pulsed explosive composition precursor or ANE flow rate provided by the ANE pump 200, the level of pressure dampening provided by the pulsation dampener 210, and the withdrawal or retraction rate of the outlet structure 700 (or analogously, the additional or final conduit or hose segment 600 to which the outlet structure 700 is structurally and fluidically coupled) from the borehole. Accordingly, the selective varying of the fill rate can include controlling/selecting the retraction rate (also known as the hose rate) based on a target bulk density (or a target bulk density profile along the borehole), wherein the target bulk density (in kg/meter) is proportional to the delivery rate (in kg/second) and inversely proportional to the retraction rate (in meters/second). In other words, the RBS is correlated to mass (in kg) of the explosive composition per length (in m) along borehole, so based on the diameter of the borehole, and the current/instantaneous flow rate, the current/instantaneous retraction rate can be controlled, during the charging, in order to provide an instantaneous target RBS at each portion along of the borehole (and thus a target RBS profile along the borehole).

It can be noted that the macro-voids 1014 are macro-scale in size, and hence are very much larger (e.g., one or typically more than one order of magnitude larger) than the dimensions of the sensitizing voids (e.g., gas bubbles) that provide or form sensitizing “hot spots” in the explosive composition or gassed ANE, where such sensitizing voids commonly have a diameter between 10-100 micrometers. Depending upon embodiment details, macro-scale can indicate or infer a dimension of at least approximately 2-10 mm (e.g., at least approximately 5-10 mm).

In some embodiments, during chemical gassing of the emulsion explosive composition (e.g., while chemical gassing reactions are occurring in-hole), the sensitizing micro-voids are being created in the emulsion explosive composition, and due to spatial/volumetric expansion of the emulsion explosive composition associated with/caused by the chemical gassing, the dimensions of at least some (e.g., multiple, many, most, or essentially all) of the as-delivered (e.g., as-initially-delivered) macro-voids (e.g., macro-voids 1014) concurrently decrease. The sensitizing micro-voids remain after the chemical gassing reactions are complete (e.g., in the final in-hole emulsion explosive composition), yet at least some of the as-delivered macro-voids (macro-voids 1014) may not remain.

In representative examples similar, relating, or corresponding to FIGS. 4A-F, and in other examples, the macro-voids 1014 occupy approximately 10%, approximately 15%, or approximately 20% of the overall spatial volume of the explosive composition or gassed ANE physical pattern 1000; each bridge or constriction/in-fill/pinch region 1020 has a length or depth range 1022 (e.g., relative to the length or lengthwise axis of the representative model borehole structure 1002) of approximately 20+/−5 mm; each macro-void or cavity 1014 has a length or depth range 1016 of approximately 50+/−10 mm; and the macro-void containing regions 1010 have a wall material of the explosive composition (including the “coating” on the walls) with a thickness 1012 of approximately 15+/−5 mm. These physical patterns may be formed by varying the flow rate repeatedly with a selected spatial frequency (and optionally a selected spatial duty cycle), and the selected spatial frequency may include one or more of: substantially 35 mm; substantially 40 mm; substantially 50 mm; and a spatial frequency such that each bridge has a longitudinal depth along the borehole of approximately 20+/−5 mm and each cavity has a longitudinal depth along the borehole of approximately 50+/−10 mm.

As shown in FIG. 4C, some or all of the macro-voids 1014 in each physical pattern may have regular shapes, e.g., with rectangular cross sections. Alternatively, some or all of the macro-voids 1014 in each physical pattern may have irregular shapes, e.g., with tear-drop cross sections, e.g., depending on which of the outlet structures (described herein) is used. For example, some or all of the macro-voids 1014 may be obliquely disposed in relation to the longitudinal borehole axis, and—in certain embodiments—a sequence of the macro-voids 1014 in a physical pattern can exhibit multiple and/or quasi-random oblique orientations, e.g., not all being tilted at the same angle, such as 30 degrees, depending on which of the outlet structures (described herein) is used.

As shown in FIG. 4C, some or all of the macro-voids 1014 in each physical pattern may be substantially centrally located in the borehole, e.g., generally along a central longitudinal axis of the borehole. Alternatively, e.g., depending on which of the outlet structures (described herein) is used, and/or depending on whether a centralizer (e.g., in the form of centering devices equivalent to those described WO199855805 (Perlid)), some or all of the macro-voids 1014 in each physical pattern may be located off-center in the borehole (e.g., with central points or centroids that are offset from the longitudinal axis of the borehole). Even when off centre, the macro-voids 1014 are typically disposed between some thickness (which can be referred to herein as a “coating”) of the explosive composition on the borehole walls.

The intentional production or provision of a pulsatile, periodic, or oscillating flow rate of explosive composition precursor and/or explosive composition in portions of an explosives composition delivery system that reside external to a borehole can produce intentional variations in the thickness of explosive composition laterally delivered or applied to the borehole sides or walls (e.g., along at least portions of the borehole's length), and more particularly, spatially periodic, spatially oscillating, or undulating explosive composition thickness variations along the sides or walls of the borehole (e.g., along those portions of the borehole's length to which the explosive composition was laterally delivered or applied). Such spatially periodic, spatially oscillating, or undulating explosive composition thickness variations along the sides or walls of the borehole can give rise to or produce spatially periodic, spatially oscillating, or undulating macro-scale compartments, cavities, or chambers and/or constrictions in the explosive composition (e.g., along those portions of the borehole's length to which the explosive composition was laterally delivered or applied).

In view of the foregoing, depending upon embodiment details (e.g., including the speed or frequency at which the ANE pump 200 is driven and/or the borehole retraction rate of the additional or final conduit or hose segment 600 and the outlet structure 700), the loading or delivery of explosive compositions or gassed ANE into boreholes can be controlled in a selective or selectable (e.g., adjustable or programmable) manner to provide explosive composition or gassed ANE physical patterns 1000 having between approximately 0%-30% (e.g., at least between approximately 0%-15%, 20%, or 25%), or between approximately 1%-30% (e.g., at least between 1%-10%, 15%, 20%, or 25%) of their volumetric content occupied by macro-voids 1014.

The presence of the macro-voids 1014 in an explosive composition or gassed ANE physical pattern 1000 provides or results in a substantial or significant reduction in the relative bulk strength (RBS) or the effective localized powder factor of the explosive composition or gassed ANE physical pattern 1000 loaded or delivered into a borehole compared to in-hole explosive compositions or gassed ANE that lack such macro-voids 1014 (e.g., which are not characterized by, do not exhibit, or lack explosive composition or gassed ANE physical pattern 1000 in accordance with an embodiment of the present disclosure). For instance, a system 10 in accordance with an embodiment of the present disclosure can load explosive composition or gassed ANE physical patterns 1000 into boreholes to have an RBS range between approximately 50 and at least 150 (e.g., from approximately 50-150, or from approximately 50 up to approximately 155, 160, 165, or 170). It can be noted that this is a surprisingly or unexpectedly wide RBS range, and this RBS range can surprisingly or unexpectedly be achieved in a selectable or selective (e.g., adjustable or programmable) manner with a system 10 in accordance with an embodiment of the present disclosure using only a single ANE formulation chemistry or base emulsion product (e.g., Orica ANE 230). In embodiments, a relative bulk strength (RBS) of the explosive composition corresponding to (i.e., including the cavities and the explosive composition) the physical pattern is one or more of the following: up to 150; up to 170; at least 50; and at least 70. In implementations requiring a plurality of target RBS values in one borehole, or across a plurality of boreholes, embodiments of the present disclosure can load a plurality of the physical patterns in the borehole, or across a plurality of boreholes, with mutually different RBS values up to 100 apart, including from 50 to 150 (e.g., for an explosive composition with substantially 20% water, and for an explosive composition with substantially 80% AN), or from 70 to 170 (e.g., for an explosive composition with substantially 17% water, and for an explosive composition with substantially 83% AN): in other words, the RBS can be dynamically varied in each borehole and across multiple boreholes—using the same explosive components and delivery system—by dynamically and selectively varying the fill rate as described herein. The RBS is correlated to mass (kg) of explosive composition per length (m) along borehole, so the target RBS may be selected, e.g., based on a blasting plan, from the known measurements of the diameter of the borehole, and then the flow rate and the retraction rate are controlled, during the charging, to provide the target RBS at each portion of the borehole.

FIG. 5A is a first graph showing velocity of detonation (VOD) VOD as a function of bulk density for particular explosive composition or gassed ANE physical patterns 1000 loaded into representative model borehole structures, which could be actual boreholes (e.g., test boreholes) in accordance with embodiments of the present disclosure. FIG. 5B is a second graph showing VOD vs. effective in-hole density, approximate or estimated macro-void percentage, and relative bulk strength (RBS) for particular explosive composition or gassed ANE physical patterns 1000 loaded into representative model borehole structures, which could analogously be actual boreholes (e.g., test boreholes), in accordance with representative embodiments of the present disclosure. As shown in FIG. 5B, in the experimental example, the relationship between VoD and density for measurements without macro-voids (crosses in circles 502) is substantially linear (following a linear plot 506) and the measurements with macro-voids (empty circles 504) are close to linear and provide lower, or significantly/substantially lower, VoD values than the measurements without macro-voids. In the experimental example of FIG. 5B, the measurements used 77-mm diameter, 3-m long tubes, and included: (a) a 19% void percentage sample giving a measured RBS of 48; (b) a 21% void percentage sample giving a measured RBS of 46; (a) a 2% void percentage sample giving a measured RBS of 67; and (a) a substantially 0% void percentage sample giving a measured RBS of 78.

In view of FIG. 5A, and 5B, based on the VOD results shown it was confirmed that VOD decreases with increasing macro-void content percentage. In FIG. 5A, the VOD results 504 were in a 73-mm diameter hole, and VOD results 506 were in a 65-mm diameter hole. That is, VOD decreases with increasing volumetric percentage of macro-voidage or macro-voids 1014 (e.g., empty space) in the explosive composition or gassed ANE physical pattern 1000 delivered into a borehole. This effect is comparable to VOD reduction that would be expected from actually chemically gassing ANE in a conventional manner (e.g., such that there are no macro-voids present) to an equivalent gassed density. It can be noted from FIGS. 5A and 5B that in-hole bulk density can be reduced below a cup density or gassed density of 0.72 g/cc (shown as a broken vertical line 502 in FIG. 5A) by way of embodiments in accordance with the present disclosure. A volumetric macro-void content percentage can be calculated as V_{M-V} %=1−(bulk density/gassed product density)×100.

The presence of the bridge or constriction/in-fill/pinch regions 1020 in the explosive composition or gassed ANE physical pattern 1000 loaded into a borehole can enhance the structural integrity of the as-loaded or as-deposited explosive composition or gassed ANE physical pattern 1000 even though macro-voids 1014 are present therein, which can significantly or dramatically reduce or minimize the likelihood that material slumping away from the borehole walls will occur. Moreover, the presence of the bridge or constriction/in-fill/pinch regions 1020 can significantly or dramatically enhance the likelihood that detonation can be sustained, or reduce or minimize the likelihood of incomplete detonation, in the explosive composition or gassed ANE physical pattern 1000 loaded or delivered into a borehole even though macro-voids 1014 are present therein, thus increasing detonation property predictability and the likelihood of achieving intended blast design objectives or outcomes.

In practice, in a system 10 configurable or configured for loading explosive compositions or gassed ANE into boreholes by way of producing explosive composition or gassed ANE physical patterns 1000, an intended or desired reduction in explosive composition or gassed ANE energy level below that which occurs, or below the practical limit of what can be reliably achieved, by density reduction through chemical gassing (e.g., chemical gassing alone) in a manner that avoids the creation of explosive composition or gassed ANE physical patterns 1000 can be achieved nominally in linear proportion to a selected or selectable volumetric macro-void content percentage.

Depending upon embodiment details, system parameters that can be selectively or selectably (e.g., adjustably or programmably) established or varied to provide an intended macro-void percentage content can include one or more of: ANE pump intake/discharge volume (e.g., which can correspond to or be correlated with piston stroke length); the rate, frequency, or periodicity of the ANE pump's operational mechanism (e.g., piston); the (pre or re)charging pressure of the pulsation dampener 210; the sensitizing or chemical gassing agent pump intake/discharge volume; the sensitizing or gassing agent flow rate; and the retraction rate of the additional or final conduit or hose segment 600/outlet structure 700 from a borehole.

FIGS. 6A-6I show further aspects (e.g., more detailed aspects) of portions or elements of a system 10 in accordance with an embodiment of the present disclosure (e.g., the system 10 of FIG. 1), including a hose coupling assembly 300, a dual channel hose 400, a stream merging assembly or structure 500, a conduit or hose outlet structure 700 in accordance with some representative embodiments in accordance with the present disclosure.

More particularly, FIGS. 6A and 6B show a representative manner in which a hose coupling assembly 300 can be fluidically coupled to a second gasser line 134 and a dual channel hose 400, which is further fluidically coupled to a stream merging assembly or structure 500, which is further fluidically coupled to an additional or final conduit or hose segment 600, which is further fluidically coupled to a conduit or hose outlet structure 700.

FIGS. 6C and 6D are schematic illustrations showing a frontal plan view and a cross-sectional view, respectfully, of a hose coupling assembly 300 in accordance with a representative embodiment of the present disclosure. The hose coupling assembly 300 is configured to receive the contents of the water-lubricated ANE line 108 and the second gasser line 134 in a physically segregated, separated, or isolated manner, and provide internal fluid flow paths by which the water-lubricated ANE stream and the gassing agent stream are fed in a physically segregated, separated, or isolated manner into the dual channel hose 400.

FIG. 6E is a schematic illustration of a cross-sectional view of a dual channel hose 400 in accordance with a representative embodiment of the present disclosure. The dual channel hose 400 is configured for carrying each of the water-lubricated ANE stream and the gassing agent stream therealong in a physically segregated, separated, or isolated manner, for instance, by way of a separate, fluidically isolated parallel internal passage corresponding to each such stream. In an embodiment, the dual channel hose 400 includes a hose body 402, which can be or typically is made of a generally flexible polymer material. The hose body 402 includes a first lumen 412 therein configured for carrying the water-lubricated ANE stream; and a second lumen therein 422 configured for carrying the gassing agent stream. The first lumen 412 is typically larger or much larger than the second lumen 422 (e.g., in view of the relative material volume or mass requirements for chemical gassing reactions), and in various embodiments the centroid or center of first lumen 412 is disposed generally centrally or centrally aligned or coincident with a lengthwise or longitudinal axis of the dual channel hose 400; and the centroid or center of the second lumen 422 is offset from the first lumen 412, yet extending parallel to the first lumen 412 with respect to the lengthwise or longitudinal axis of the dual channel hose 400. In various embodiments, at least the first lumen 412 can have an internal surface configured or formed to reduce adherence of the water-lubricated ANE stream thereto, which reduces disruption and/or aids smooth conveyance of the water-lubricated within the dual channel hose 400. Such an internal surface can be of a type described in U.S. Pat. No. 10,557,575. In a representative implementation for underground commercial blasting (e.g., mining) applications, the dual channel hose 400 can have a diameter of approximately 2.0-2.5 inches (e.g., approximately 2.0 inches), particularly in embodiments that include a first lumen 412 having such an internal surface.

With reference again to FIGS. 6C and 6D, particular details of the hose coupling assembly 300 and portions of the dual channel hose 400 are shown. In an embodiment, the hose coupling assembly 300 includes a main body 302 providing a first inlet port structure 310 that is structurally and fluidically couplable to the water-lubricated ANE line 108 (e.g., by way of a first fitting 311 by which the first inlet port structure 310 and the water-lubricated ANE line 108 can be securely matingly engaged), and which is fluidically coupled to a first lumen 312 in the main body 302 of the hose coupling assembly 300. The main body 302 further includes a second inlet port structure 320 that is structurally and fluidically couplable to the second gasser line 134 (e.g., by way of a second fitting 321 by which second inlet port structure 320 and the second gasser line 134 can be securely matingly engaged), and which is fluidically coupled to a second lumen 322 in the body of the hose coupling assembly 300.

The first lumen 312 leads and is fluidically coupled to a first outlet port structure 330 of the hose coupling assembly 300, which is configured for alignment with and fluidic coupling to the first lumen 412 of the dual channel hose 400. The second lumen 322 leads to and is fluidically coupled to a second outlet port structure 340 of the hose coupling assembly 300, which is configured for alignment with and fluidic coupling to the second lumen 422 of the dual channel hose 400. In various embodiments, the first outlet port structure 330 and the dual channel hose's first lumen 412 as well as the second outlet port structure 340 and the dual channel hose's second lumen 422 are each self-aligned and securely matingly engaged by way of an appropriate set of fittings, such as an output fitting 331 carried by the hose coupling assembly 300 which securely matingly engages with a first terminal fitting 411 corresponding to a first terminal section or end of the dual channel hose 400.

The stream merging structure or assembly 500 is configured for securely matingly engaging with the dual channel hose 400, receiving the physically separated water-lubricated ANE stream and the gassing agent stream therefrom, and introducing or injecting the gassing agent stream into the water-lubricated ANE stream to form a combined ANE—gassing agent stream, such that mixing of the water-lubricated ANE stream with the gassing agent stream is initiated and reaction of the AN with the gassing agent proceeds. Further aspects of stream merging structures or assemblies in accordance with particular embodiments of the present disclosure are described hereafter.

FIG. 6F is a schematic illustration of a first stream merging assembly or structure 500a in accordance with a representative embodiment of the present disclosure. In an embodiment, the first stream merging assembly or structure 500a includes a first body structure 502a having an input interface 503 configured for secure mating engagement with a counterpart output interface at second terminal section or end of the dual channel hose 400; and an output interface 505 configured for secure mating engagement with a counterpart input interface at a first terminal section or end of the additional or final conduit or hose segment 600.

As indicated in FIG. 6F, the additional or final conduit or hose segment 600 includes a lumen therein 612. When the first stream merging assembly or structure 500a and the dual channel hose 400 are matingly engaged, the first body structure 502a is configured to receive the water-lubricated ANE stream flowing in the first lumen 412 of the dual channel hose 400, such as by way of mating insertion of or engagement between and fluidic coupling with an input coupling element 540 of the first body structure 502a and the first lumen 412 of the dual channel hose 400, and by which fluidic coupling of the first lumen 412 of the dual channel hose 400 and a gassing agent distribution ring 530 can also occur, as further described hereafter.

The first body structure 502a also includes a duct or tube 520 that is aligned (e.g., self-aligned) with and fluidically coupled to the second lumen 422 of the dual channel hose 400 when the first stream merging assembly or structure 500a and the dual channel hose 400 are matingly engaged, such that the gassing agent stream concurrently flows from the dual channel hose's second lumen 422 into this duct or tube 520. The first stream merging assembly or structure 500a also includes a first set of flow diversion structures 532a configured for directing or diverting the gassing agent stream flowing in the duct or tube 520 into a gassing agent distribution ring 530 fluidically coupled thereto, and which is fluidically coupled to and which surrounds or which is peripherally or circumferentially disposed or aligned relative to each of the first lumen 412 of the dual channel hose 400 and the lumen 612 of the additional or final conduit or hose segment 600, such that the gassing agent stream is introduced or injected into the water-lubricated ANE stream as the water-lubricated ANE stream exits the dual channel hose and enters the lumen 612 of the additional or final conduit or hose segment 600, to thereby form the combined ANE gassing agent stream (which subsequently becomes an explosive composition stream or gassed ANE stream).

FIG. 6G is a schematic illustration of a second stream merging assembly or structure 500b in accordance with a representative embodiment of the present disclosure, which includes a Venturi-type lumen structure 550 therein. The second stream merging assembly or structure 500b includes a second body structure 502b having an input interface 503 configured for secure mating engagement with a counterpart output interface at second terminal section or end of the dual channel hose 400; and an output interface 505 configured for secure mating engagement with a counterpart input interface at a first terminal section or end of the additional or final conduit or hose segment 600.

The Venturi-type lumen structure 550 includes a converging portion 552, a throat portion 554, a diverging portion 556, and an injector structure 558. Sequentially along the length of the Venturi-type lumen structure 550, the converging portion 552 is fluidically coupled to the throat portion 554, which is fluidically coupled to the diverging portion 556. The injector structure 558 is fluidically coupled to the throat portion 554, such that a fluid can be introduced or injected therein.

When the second stream merging assembly or structure 500b and the dual channel hose 400 are matingly engaged, the second body structure 502b is configured to receive the water-lubricated ANE stream flowing in the first lumen 412 of the dual channel hose 400, such as by way of mating insertion of or engagement and fluidic coupling between the converging portion 552 of the Venturi-type lumen structure 550 and the first terminal section of the dual channel hose 400.

The second stream merging assembly or structure 500b includes a duct or tube 520 that is aligned (e.g., self-aligned) with and fluidically coupled to the second lumen 422 of the dual channel hose 400 when the second stream merging assembly or structure 500b and the dual channel hose 400 are matingly engaged, such that the gassing agent stream concurrently flows from the dual channel hose's second lumen 422 into this duct or tube 520. The second stream merging assembly or structure 500b also includes a second set of flow diversion structures 532b configured for directing or diverting the gassing agent stream flowing in the duct or tube 520 into the injector structure 558, whereby the gassing agent stream is introduced or injected into the throat portion 554 of the Venturi-type lumen structure 550 and thereby introduced or injected into the water-lubricated ANE stream that concurrently flows from the converging portion 552 into the throat potion 554, thus initially forming the combined ANE-gassing agent stream (which subsequently becomes the explosive composition stream or gassed ANE stream). Individuals having ordinary skill in the relevant art will understand that the second stream merging assembly's Venturi-type lumen structure 500 can be defined as or provides a type of Venturi effect dispersion/mixing device. The initially-formed combined ANE-gassing agent stream flows from the throat portion 554 into the diverging portion 556 of the Venturi-type lumen structure 550, and thus into the lumen 612 of the additional or final conduit or hose segment 600 that is matingly engaged with the second stream merging assembly or structure 500b.

FIGS. 6H and 6I are schematic illustrations of a first and a second conduit or hose outlet structure 700a, b, respectively, in accordance with representative embodiments of the present disclosure. As indicated in FIG. 6H, the first conduit or hose outlet structure 700a includes a first body structure 702a having an inlet coupling portion 703a configured for mating engagement with a second terminal section or end of the additional or final conduit or hose segment 600, such that a first or input lumen 712a of the first conduit or hose outlet structure 700a is fluidically coupled to the lumen 612 of the additional or final conduit or hose segment 600. The first body structure 702b also includes an outlet coupling portion 705a having a second or output lumen 722a that is fluidically coupled to the first or input lumen 712a, and which is further fluidically coupled to a dispensing/spray nozzle 750a configured for laterally dispensing or ejecting explosive composition or gassed ANE, that, is primarily, nearly entirely, or essentially entirely in a circumferential manner around the dispensing/spray nozzle 750a toward the sides or walls of a borehole (rather than primarily, nearly entirely, or essentially entirely toward the terminal or distal end or bottom of the borehole).

As indicated in FIG. 6I, the second conduit or hose outlet structure 700b includes a second body structure 702b having an inlet coupling portion 703b and an output coupling portion 705b. The input coupling portion 703b is configured for mating engagement with the second terminal section or end of the additional or final conduit or hose segment 600, such that a first or input lumen 712a of the second conduit or hose outlet structure 700a can be selectively, selectably, or pressure-responsively fluidically coupled to the lumen 612 of the additional or final conduit or hose segment 600. The output coupling portion 705b is configured for mating engagement with a dispensing/spray nozzle 750b, which has a second lumen 722b therein that is fluidically coupled to the first lumen 712b.

More particularly, in an embodiment, the second conduit or hose outlet structure 700b includes a resiliently biased or spring-based plunger mechanism 752 disposed within the first or input lumen 712b, which is maintained in position against a first or distal seat structure 740 associated with or corresponding to the output coupling portion 705b, and which can selectively abut or be displaced or released away from a second or proximal seat structure 742 that forms an interface between the first or input lumen 712a and the lumen 612 of the additional or final conduit or hose segment 600. In response to pressure corresponding to input-to-output directional fluid flow, explosive composition or gassed ANE can flow from the lumen 612 of the additional or final conduit or hose segment 600 into in the first lumen 712b and second lumen 722b of the second conduit or hose outlet structure 700b, and be laterally dispensed or ejected from the dispensing/spray nozzle 750 by way of an angled dispensing/spray channel, opening, or port 758 (e.g., which laterally dispenses or ejects explosive composition or gassed ANE toward and onto the sides or walls of a borehole primarily at an angle or across an angle range, for instance, relative to a lengthwise or longitudinal axis of the borehole, such as described above). The explosive composition or gassed ANE is thus dispensed or ejected primarily, nearly entirely, or essentially entirely in a circumferential manner around the dispensing/spray nozzle 750b toward the sides or walls of a borehole (rather than primarily, nearly entirely, or essentially entirely toward the terminal end or bottom of the borehole).

It can be noted that the lumens and other fluid-exposed internal structures or portions of one or more of the stream merging assembly 500, the additional or final conduit hose segment 600, and the outlet structure 700 can have internal surfaces configured or formed to reduce adherence of explosive composition constituents and/or explosive compositions thereto, and reduce disruption and/or aid smooth conveyance of explosive composition constituents and/or explosive compositions therealong or therein. Such internal surfaces can be of a type described in U.S. Pat. No. 10,557,575.

FIGS. 7A and 7B are a schematic illustrations of a nozzle assembly 700c forming a third conduit or hose outlet structure in accordance with representative embodiments of the present disclosure. As shown in FIGS. 7B and 7E, the nozzle assembly 700c includes the following (e.g., made from stainless steel unless otherwise specified):
a. a nozzle tip 702;
b. a nozzle threaded nipple 704;
c. a nozzle valve core 706;
d. a dowel 708;
e. a spring 710;
f. a poppet 712, e.g., made from a hard engineering plastic;
g. a nozzle valve housing 714;
h. a check valve body 728;
i. a check valve assembly 730;
j. a dual channel hose connection 732; and
k. a deflector 722 that extends beyond the nozzle tip 702 to deflect the explosive composition towards the walls of the borehole during the dispensing.

As shown in FIG. 7C, in this embodiment, the nozzle tip 702 includes a set of dispersion facets 716 in the outlet end face (which may be referred to as the “terminal face”) of the nozzle tip 702.

As shown in FIG. 7D, the nozzle tip 702 includes:
a. a first set of ports (also referred to as “primary dispersion ports” or “primary ejection ports”) provided by cuts 718 in the outer radial surface of the nozzle tip 702; and
b. a second set of ports (also referred to as “secondary dispersion ports” or “secondary ejection ports”) provided by the set of dispersion facets 716 in the outlet end face of the nozzle tip 702.

In use, the primary dispersion ports are closer to the mouth of the borehole than the secondary dispersion ports, so the explosive composition from the primary dispersion ports is delivered into the borehole first (e.g., sticking to the walls of the borehole), and the explosive composition from the secondary dispersion ports is delivered onto or into the explosive composition from the primary dispersion ports (e.g., sticking to the already in-place explosive composition). The primary dispersion ports deliver the explosive composition onto the walls to form an at least partial coating of the explosive composition on the walls of the borehole, and then the secondary dispersion ports deliver the explosive composition at least partially onto the coating formed by the primary dispersion ports-the at least partial coating can assist adherence of the explosive composition from the secondary dispersion ports to the walls. As shown in FIGS. 7A-7K , the nozzle tip 702 can include 8 primary dispersion ports in the form of 8 cuts 718 mutually evenly circumferentially spaced around an outer side wall of the nozzle tip 702. In alternative embodiments, the nozzle tip 702 can include 4 to 16 primary dispersion ports in the form of 4 to 16 cuts 718 mutually evenly circumferentially spaced around the nozzle tip 702: having more primary ports may allow for a more uniform coating, although a minimum size of the primary ports/cuts 718 can be limited by viscosity of the explosive composition.

The secondary dispersion ports may be configured to deliver the explosive composition in a set of helical streams, which may improve formation of the physical pattern, e.g., by improved adherence to the coating on the walls from the primary ports, and may improve gassing of the explosive composition by mixing with air in the borehole. The set of helical streams are ejected from the second set of ports provided by the set of dispersion facets 716. As shown in FIG. 7H, the dispersion facets 716 are mutually evenly spaced around, forming a circle, the centre of the outlet end face of the nozzle tip 702. In the embodiment of FIGS. 7A-M , there are 10 dispersion facets 716 and thus 10 secondary dispersion ports; however, in other embodiments, the nozzle tip 702 has 8 dispersion facets 716 and thus 8 secondary dispersion ports configured for ejecting 8 helical streams of the explosive composition. In other embodiments, the nozzle 702 has 8 to 10 dispersion facets 716 (thus 8 to 10 respective secondary dispersion ports and helical streams). In other embodiments, the nozzle 702 has 6 to 12 dispersion facets 716 (thus 6 to 12 respective secondary dispersion ports and helical streams). In other embodiments, the nozzle 702 has 4 to 14 dispersion facets 716 (thus 4 to 14 respective secondary dispersion ports and helical streams). The dispersion facets 716 are typically evenly and circumferentially distributed around the outlet end face of the nozzle tip 702, and for 10 dispersion facets 716, each can extend around an angle of substantially 36 degrees.

The plurality of helical streams may overlap each other while being ejected from the secondary ports.

The primary ports may eject the explosive composition at a first angle relative to a longitudinal axis of a hose corresponding to an angle of the primary ports (e.g., see cuts 718 in FIG. 71-K) , and the secondary ports eject the explosive composition at a second angle relative to the longitudinal axis of the hose corresponding to an angle of the secondary ports (e.g., see facets 716 in FIG. 7J and in FIG. 7D including the deflector 722), wherein the second angle is different from the first angle.

Use of the nozzle assembly 700c may allow for controlled production of the physical pattern without requiring a centralizer, e.g., in the form of a pair of centering devices arranged on the hose close to the outlet structure to keep the charging hose centered in the borehole during the formation of the physical pattern. The nozzle assembly 700c may form the cavities in the physical pattern in irregular shapes, e.g., substantially off centre and/or with irregular cross sections; however, the RBS of the portion of the explosive material with the physical pattern of the cavities (and bridges) still can be controlled by controlling the fill rate as described herein before.

As shown in FIG. 7E, the primary dispersion ports includes saw slots 720 extending into the interior of the nozzle tip 702 and fluidically coupled to the cuts 718.

As shown in FIG. 7E, the nozzle assembly 700c includes a deflector 722 that extends beyond the nozzle tip 702 to deflect the explosive composition towards the walls of the borehole during the dispensing.

As shown in FIG. 7E, the nozzle assembly 700c includes a swirl chamber 724 inside the nozzle tip 702 in which the explosive composition swirls prior to ejection by the primary dispersion ports and the secondary dispersion ports.

As shown in FIG. 7E, the nozzle assembly 700c includes a mixer 726 for mixing the explosive composition prior to the swirling and prior to the ejection. As shown in FIG. 7F, the mixer 726 can include a plurality of circumferentially distributed bladed vanes, e.g., 5 bladed vanes.

In embodiments, the dimensions in the drawings of FIGS. 7A-M , given in millimeters and angular degrees, can vary by +/−20%, depending on embodiment details, e.g., the hose diameter and the number of dispersion ports.

### Aspects of Representative Explosive Composition Loading Techniques, Processes, or Methods

A system 10 in accordance with an embodiment of the present disclosure can load or deliver explosive compositions into an array of boreholes in a manner that provides in-hole explosive compositions having different or multiple distinct characteristics or properties (e.g., explosive composition energies, effective in-hole densities, VOD values, and/or RBS values) (a) between particular sets or groups of boreholes or from one borehole to another; and/or (b) within a given borehole (e.g., along the length or longitudinal axis thereof), where such explosive composition characteristics or properties (between individual boreholes, and/or within or along an individual borehole) can be selectively or selectably (e.g., adjustably or programmably) established or changed/varied (e.g., based on differing lithologies or rock properties across or within a geologic formation, such as determined by way of MWD signals or values determined in association with borehole drilling operations), including in at least some embodiments on an essentially on-the-fly, near-real-time, or near-instantaneous basis.

Between boreholes (e.g., from one borehole to another) and/or within individual boreholes, borehole loading with explosive compositions having different or multiple distinct characteristics or properties can be provided by way of intentionally loading or delivering explosive compositions characterized by or exhibiting multiple different explosive composition physical patterns 1000; or intentionally loading or delivering a set of explosive compositions characterized by or exhibiting one or more distinct explosive composition physical patterns 1000, and another set of explosive compositions that intentionally lack or exclude explosive composition physical patterns 1000.

As a representative non-limiting example, a system 10 in accordance with an embodiment of the present disclosure can load or deliver explosive compositions into a group of boreholes formed in or across portions of a geologic formation such that at least two of: (i) a first array of boreholes intentionally includes or is loaded with a first explosive composition characterized by a first explosive composition physical pattern 1000a (e.g., having a first non-zero volumetric percentage or percentage range of macro-void content), for instance, based on a first set of rock properties or rock property values associated with the first array of boreholes; (ii) a second array of boreholes intentionally includes or is loaded with a second explosive composition characterized by a second explosive composition physical pattern 1000b (e.g., having a distinct second non-zero volumetric percentage or percentage range of macro-void content), for instance, based on a second set of rock properties or rock property values associated with the second array of boreholes; and (iii) a third array of boreholes intentionally includes or is loaded with a third explosive composition that lacks explosive composition physical patterns 1000, such that the volumetric macro-void content of the third explosive composition is zero, or the third array of boreholes intentionally omits or excludes any explosive composition having an explosive composition physical pattern 1000, for instance, based on a third set of rock properties or rock property values associated with the third array of boreholes.

Additionally or alternatively, a particular set of boreholes within a given array of boreholes (e.g., one or more boreholes within the aforementioned first array of boreholes or the second array of boreholes) can be loaded such the explosive compositions loaded into each borehole within the particular set of boreholes are characterized by or exhibit two or more distinct explosive composition physical patterns 1000 (e.g., corresponding to two different non-zero macro-void content percentages or percentage ranges) along the lengthwise or longitudinal axes of such boreholes.

Aspects of particular embodiments of the present disclosure address at least one aspect, problem, limitation, and/or disadvantage associated with existing explosive composition loading systems, apparatuses, and processes. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope of the present disclosure. For instance, systems in accordance with embodiments of the present disclosure can include additional or other reservoirs/tanks plus corresponding conduits or lines, pumps, and flow meters. One or more reservoirs/tanks can contain materials or material compositions or additives therefor that are not mentioned or which are different than those described above. An explosive composition precursor can carry or have introduced therein non-chemically formed sensitizing agents.

1-103. (canceled)

104. A method of charging at least one borehole for commercial blasting, the method comprising:
charging a borehole with an explosive composition by dispensing the explosive composition from an outlet structure in the borehole; and
selectively varying, while charging the borehole, a fill rate of the explosive composition into the borehole to provide at least one physical pattern in the explosive composition that includes two or more cavities,
and wherein the selective varying of the fill rate selectively controls sizes and locations of the two or more cavities.

105. The method of claim 104, wherein the selective varying of the fill rate includes at least one of: (i) selective varying of a retraction rate of the outlet structure from the borehole, (ii) controlling or selecting the retraction rate based on a target bulk density, wherein the target bulk density is proportional to the delivery rate and inversely proportional to the retraction rate, and (iii) selective varying of a flow rate of the explosive composition from the outlet structure, wherein the flow rate of the explosive composition from the outlet structure varies repeatedly as a function of time in a manner that is correlated with the physical pattern.

106. The method of claim 105, wherein the flow rate of the explosive composition from the outlet structure varies repeatedly as a function of time in a manner that is correlated with repeated variation in a flow rate of an explosive composition precursor stream that is used to form the explosive composition.

107. The method of claim 106, including:
producing the explosive composition precursor stream;
producing a sensitizing agent stream having a selectively or selectably established flow rate; and
merging the sensitizing agent stream and the explosive composition stream to produce a combined stream that forms the explosive composition that is used to provide the physical pattern, and
wherein the method includes flowing the explosive composition precursor stream and the sensitizing agent stream in a multi-channel hose, and mixing the sensitizing agent stream and the explosive precursor composition stream, to form the explosive composition, by flow of the sensitizing agent stream and the explosive precursor composition stream through one or more of:
in a Venturi-type lumen structure,
a portion of the multi-channel hose,
one or more static mixers in the outlet structure and/or in a final segment of the multi-channel hose, and
the outlet structure.

108. The method of claim 107, further comprising:
injecting the explosive composition precursor stream into a lubrication water stream to produce a water-lubricated explosive composition precursor stream having an explosive composition precursor core surrounded by an annulus of water,
wherein the lubrication water stream varies repeatedly as a function of time in a manner that is correlated with the repeated variation in the flow rate of the explosive composition precursor stream.

109. The method of claim 104, further comprising:
dispensing the explosive composition from the outlet structure laterally toward side walls of the borehole when the outlet structure is disposed in the borehole; and
laterally dispensing the explosive composition toward and onto the sides or walls of a borehole predominantly at or at an angle of 70 degrees offset from a lengthwise or longitudinal axis of a borehole in a vector direction opposite to a vector direction along which the outlet structure is retracted or withdrawn from the borehole, or an angle range of 60-80 degrees offset of the lengthwise or longitudinal axis of the borehole in a vector direction opposite to a vector direction along which the outlet structure is retracted or withdrawn from the borehole.

110. The method of claim 104, further comprising charging a selected borehole with two or more mutually distinct explosive composition physical patterns along a lengthwise axis of the selected borehole.

111. The method of claim 104, further comprising forming a plurality of physical patterns in one borehole, or across a plurality of boreholes, to provide mutually different RBS values up to 100 apart, including from 50 to 150, or from 70 to 170.

112. The method of claim 104, wherein the cavities are at least one order of magnitude larger than sensitizing voids in the explosive composition.

113. The method of claim 112, wherein the sensitizing voids have an average diameter of between 10 and 100 micrometers, and wherein the cavities have an average diameter of at least approximately 2 to 10 mm, or at least approximately 5 to 10 mm.

114. A system for charging at least one borehole for commercial blasting, the system comprising:
an outlet structure for dispensing an explosive composition in the borehole to charge the borehole with the explosive composition; and
a control system for selectively varying, while charging the borehole, a fill rate of the explosive composition into the borehole to provide at least one physical pattern in the explosive composition that includes two or more cavities,
wherein the selective varying of the fill rate selectively controls sizes and locations of the two or more cavities.

115. The system of claim 114, wherein the selective varying of the fill rate includes at least one of (i) selective varying of a retraction rate of the outlet structure from the borehole, (ii) controlling or selecting the retraction rate based on a target bulk density, wherein the target bulk density is proportional to the delivery rate and inversely proportional to the retraction rate, and (iii) selective varying of a flow rate of the explosive composition from the outlet structure, wherein the flow rate of the explosive composition from the outlet structure varies repeatedly as a function of time in a manner that is correlated with the physical pattern.

116. The system of claim 115, wherein the flow rate of the explosive composition from the outlet structure varies repeatedly as a function of time in a manner that is correlated with repeated variation in a flow rate of an explosive composition precursor stream that is used to form the explosive composition.

117. The system of claim 116, including:
an explosive composition precursor pump configured to produce the explosive composition precursor stream;
a sensitizing agent pump fluidically coupled to a flow meter/controller, wherein the sensitizing agent pump and the flow meter/controller are configured to produce a sensitizing agent stream having a selectively or selectably established flow rate; and
a stream merging assembly configured to merge the sensitizing agent stream and the explosive composition stream that forms the explosive composition to provide the physical pattern in the explosive composition,
wherein the system includes a multi-channel hose for flowing the explosive composition precursor stream in a first lumen and the sensitizing agent stream in a second lumen, and wherein one or more of the following is configured to mix the sensitizing stream and the explosive precursor composition stream, to form the explosive composition:
a Venturi-type lumen structure,
a portion of the multi-channel hose,
one or more static mixers in the outlet structure and/or in a final segment of the multi-channel hose, and
the outlet structure.

118. The system claim 117, including:
a lubrication water pump configured to produce a lubrication water stream;
a lubrication water injector configured to produce a water-lubricated explosive composition precursor stream having an explosive composition precursor core surrounded by an annulus of water,
wherein, the lubrication water pump includes an operational mechanism that is driven by the control system to repeatedly vary the lubrication water stream as a function of time in a manner that is correlated with the repeated variation in the flow rate of the explosive composition precursor stream.

119. The system of claim 114, wherein the outlet structure includes at least one outlet port, the at least one output port is configured to laterally dispense the explosive composition toward and onto the sides or walls of a borehole predominantly at or at an angle of 70 degrees offset from a lengthwise or longitudinal axis of a borehole in a vector direction opposite to a vector direction along which the outlet structure is retracted or withdrawn from the borehole, or an angle range of 60-80 degrees offset of the lengthwise or longitudinal axis of the borehole in a vector direction opposite to a vector direction along which the outlet structure is retracted or withdrawn from the borehole.

120. The system of claim 114, wherein a selected borehole is charged with two or more mutually distinct explosive composition physical patterns along a lengthwise axis of the selected borehole.

121. The system of claim 114, including forming a plurality of physical patterns in one borehole, or across a plurality of boreholes, to provide mutually different RBS values up to 100 apart, including from 50 to 150, or from 70 to 170.

122. The system of claim 114, wherein the cavities are at least one order of magnitude larger than sensitizing voids in the explosive composition.

123. The system of claim 122, wherein the sensitizing voids have an average diameter of between 10 and 100 micrometers, and wherein the cavities have an average diameter of at least approximately 2 to 10 mm, or at least approximately 5 to 10 mm.
